(19) United States
(12) Patent Application Publication
(10) Pub. No.: US 2018/0335107 A1
(43) Pub. Date: Nov. 22, 2018

(54) TORQUE TRANSMITTING MEMBERS FOR UNIFORMED SURFACE CONE

(71) Applicant: Armin Sebastian Tay, West Covina, CA (US)

(72) Inventor: Armin Sebastian Tay, West Covina, CA (US)

(21) Appl. No.: 15/965,948

(22) Filed: Apr. 29, 2018

Related U.S. Application Data
(63) Continuation-in-part of application No. 62/534,688, filed on Jul. 20, 2017.
(60) Provisional application No. 62/506,612, filed on May 16, 2017.
(60) Provisional application No. 62/511,362, filed on May 26, 2017.
(60) Provisional application No. 62/522,694, filed on Jun. 21, 2017.
(60) Provisional application No. 62/571,790, filed on Oct. 13, 2017.
(60) Provisional application No. 62/590,471, filed on Nov. 24, 2017.
(60) Provisional application No. 62/641,360, filed on Mar. 11, 2018.
(60) Provisional application No. 62/647,793, filed on Mar. 25, 2018.
(60) Provisional application No. 62/654,489, filed on Apr. 8, 2018.
(60) Provisional application No. 62/657,839, filed on Apr. 15, 2018.
(60) Provisional application No. 62/661,090, filed on Apr. 23, 2018.

(51) Int. Cl. F16G 13/06; F16H 9/24

(52) U.S. Cl. CPC F16G 13/06; F16H 9/24

(57) ABSTRACT

A Torque Transmitting Chain Member (FIGS. 28 and 29), a Non-Torque Transmitting Chain Member (FIGS. 46 and 47), and an Inverted Toothed Leveling Loop (FIGS. 54 to 57) that can be used to construct a cheaper and better performing cone for toothed CVTs; by: a) allowing for the use of a uniformed surface cone, instead of a cone that has raised and recessed surfaces to account for the base of the Torque Transmitting Chain Member and Non-Torque Transmitting Chain Member; and by b) allowing for smooth and efficient torque transmission by having the chain used with said cone resting on an Inverted Toothed Leveling Loop that is always resting on the surface of its cone regardless of whether the Torque Transmitting Chain Member and/or Non-Torque Transmitting Chain Member are engaged with their chain or not.

### CROSS-REFERENCE TO RELATED APPLICATIONS

This invention is entitled to the benefits of:
Provisional Patent Application (PPA) Ser. No. 62/506,612 filed on 16 May 2017
Provisional Patent Application (PPA) Ser. No. 62/511,362 filed on 26 May 2017
Provisional Patent Application (PPA) Ser. No. 62/522,694 filed on 21 Jun. 2017
Provisional Patent Application (PPA) Ser. No. 62/534,688 filed on 20 Jul. 2017
Provisional Patent Application (PPA) Ser. No. 62/571,790 filed on 13 Oct. 2017
Provisional Patent Application (PPA) Ser. No. 62/590,471 filed on 24 Nov. 2017
Provisional Patent Application (PPA) Ser. No. 62/641,360 filed on 11 Mar. 2018
Provisional Patent Application (PPA) Ser. No. 62/647,793 filed on 25 Mar. 2018
Provisional Patent Application (PPA) Ser. No. 62/654,489 filed on 8 Apr. 2018
Provisional Patent Application (PPA) Ser. No. 62/657,839 filed on 15 Apr. 2018
Provisional Patent Application (PPA) Ser. No. 62/661,090 filed on 23 Apr. 2018

The following previously filed patents and patent applications have no legal bearing on this application; they describe items mentioned in this application (i.e. cone with one torque transmitting member), but the subject matter claimed in this application is different and has not been previously disclosed in the following previously filed patents and patent applications:
U.S. Pat. No. 6,656,070, which was filed on 11 Jan. 2001
U.S. Pat. No. 8,628,439, which was filed on 29 Oct. 2007
U.S. Pat. No. 9,651,123, which was filed on 27 Jun. 2015
U.S. patent application Ser. No. 14/557,454 (Pub. No. 20150135895), which was filed on 2 Dec. 2014
U.S. patent application Ser. No. 15/130,924 (Pub. No. 20160334014), which was filed on 15 Apr. 2016

BACKGROUND

### Field of Invention

This invention relates to torque/speed transmissions, specifically to improvements for a cone assembly that can be used to construct Continuously Variable Transmissions (CVTs).

### Description of Prior Art

The inventions of this disclosure are primarily for a “cone with one torque transmitting member” described in U.S. Pat. No. 8,628,439.

A “cone with one torque transmitting member” of U.S. Pat. No. 8,628,439 (which is referred to as a front pin belt cone assembly 520A) is described in column 90 line 64 to column 99 line 11; and shown in FIGS. 91A, 91B, 92A, 92B, 93 to 101 of the Published Patent.

A “cone with one torque transmitting member” is basically a cone that has a “torque transmitting member” that is rotatably fixed relative to the surface of its cone, but can slide axially relative to the surface of its cone. The “torque transmitting member” is used for torque transmission and can be made toothed. Preferably (although not absolutely necessary), a “cone with one torque transmitting member” also has a “non-torque transmitting member”, which is primarily used to maintain the alignment of the transmission belt of its cone and balance-out the centrifugal forces of the “torque transmitting member”. For the cone with one torque transmitting member of U.S. Pat. No. 8,628,439, which is referenced in the previous paragraph, the a “torque transmitting member” is labeled as “pin belt torque transmitting member 590” and the “non-torque transmitting member” is labeled as “pin belt non-torque transmitting member 690”.

An example of CVT that is constructed of out of two “cone with one torque transmitting member”, which are labeled as Cone 1A and Cone 1B, is shown in FIGS. 1 to 4. This CVT comprises of Cone 1A mounted on one spline that is coupled by a Transmission Belt 2 (which can be replaced with a chain in an alternate configuration) to a Cone 1B mounted on another spline. A Tensioning Pulley 3, positioned on the slack side of Transmission Belt 2, is used to maintain proper tension in Transmission Belt 2 as the axial position of the cones are changed independent of each other. And a Support Pulley 4 is used to ensure that for each cone at least a portion of its torque transmitting member is engaged with Transmission Belt 2 for torque transmission at all times.

Cones 1A and 1B are each a “cone with one torque transmitting member”. Cone 1A has a Torque Transmitting Member 1A-M1, Non-Torque Transmitting Member 1A-M2, and a Leveling Loop 1A-M3. Cone 1B has a Torque Transmitting Member 1B-M1, Non-torque Transmitting Member 1B-M2, and a Leveling Loop 1B-M3. Torque transmitting members 1A-M1 and 1B-M1 have teeth so that toothed torque transmission can be used, although friction torque transmitting members can also be used.

A leveling loop, such as Leveling Loop 1A-M3 and Leveling Loop 1B-M3, is a flexible loop with a tapered bottom surface that provides a level top resting surface for a transmission belt. It is recommended that each leveling loop is made out of a low friction flexible material that can expand and contract accordingly with the expansion and contraction of its cone; otherwise the CVT needs to be configured so that the leveling loops do not get in the way as the transmission ratio of their CVT is changed.

Tensioning Pulley 3 acts as a support pulley and tensioning pulley. Tensioning Pulley 3 and Support Pulley 4 are mounted so that they can freely move sideways in the horizontal direction. And Tensioning Pulley 3 is pushed upwards in the vertical direction so that it can maintain proper tension in Transmission Belt 2 for all operating conditions of the CVT.

### Other Prior Arts

The following prior art that might also be relevant: U.S. Pat. No. 7,713,153; Issue Date: May 11, 2010; Patentee: Naude.

### BRIEF SUMMARY OF THE INVENTION

For the cone assemblies of the prior art, the height of the surfaces of a cone that will not be covered by a torque transmitting member and a non-torque transmitting member have to be raised relative to the surfaces of a cone that will be covered by a torque transmitting member and a non-torque transmitting member in order to allow for round resting surface for a transmission belt or chain. The invention of this disclosure will introduce torque transmitting members and non-torque transmitting members that can be used with a Uniformed Surfaced Cone, which is a cone that has a smooth and even resting surface for a transmission belt or chain.

Being able to use a Uniformed Surfaced Cone instead of a cone for which some surfaces are raised in order to compensate for the bases of its Torque Transmitting Chain Member and Non-Torque Transmitting Chain Member will reduce the cost of a cone considerably; since otherwise the height of the surfaces of the cone that will not be covered by a Torque Transmitting Chain Member or a Non-Torque Transmitting Chain Member have to be raised relative to the surfaces of the cone that will be covered in order to allow for a smooth and even resting surface for a transmission belt or chain. The manufacturing of Uniformed Surfaced Cone can be similar to that that of a bucket; this will eliminate the high cost due to casting for tight tolerances.

### BRIEF DESCRIPTION OF THE SEVERAL VIEWS OF THE DRAWING

FIG. 1 shows a front-view of a CVT that is constructed of out of two “cone with one torque transmitting member”.

FIG. 2 shows a partial top-view of a CVT that is constructed of out of two “cone with one torque transmitting member”.

FIG. 3 shows another front-view of a CVT that is constructed of out of two “cone with one torque transmitting member”.

FIG. 4 shows another partial top-view of a CVT that is constructed of out of two “cone with one torque transmitting member”.

FIG. 5 shows a side-view of Joiner Plate 5.

FIG. 6 shows a top-view of Joiner Plate 5.

FIG. 7 shows a side-view of Alternate Joiner Plate 5A.

FIG. 8 shows a top-view of Alternate Joiner Plate 5A.

FIG. 9 shows a top-view of Alternate Joiner Plate 5A for which its Pin 5A-M1 has been removed.

FIG. 10 shows a top-view of Pin 5A-M1.

FIG. 11 shows a rear-view of Link 6A.

FIG. 12 shows a side-view of Link 6A.

FIG. 13 shows a top-view of Link 6A.

FIG. 14 shows a rear-view of Link 6B.

FIG. 15 shows a side-view of Link 6B.

FIG. 16 shows a top-view of Link 6B.

FIG. 17 shows a rear-view of Leading End Torque Transmitting Chain Member 7.

FIG. 18 shows a side-view of Leading End Torque Transmitting Chain Member 7.

FIG. 19 shows a top-view of Leading End Torque Transmitting Chain Member 7.

FIG. 20 shows a rear-view of Trailing End Link 8.

FIG. 21 shows a side-view of Trailing End Link 8.

FIG. 22 shows a top-view of Trailing End Link 8.

FIG. 23 shows a rear-view of Trailing End Joiner Plate 5B.

FIG. 24 shows a side-view of Trailing End Joiner Plate 5B.

FIG. 25 shows a top-view of Trailing End Joiner Plate 5B.

FIG. 26 shows a side-view of Torque Transmitting Chain Member 9.

FIG. 27 shows a top-view of Torque Transmitting Chain Member 9.

FIG. 28 shows a side-view of Torque Transmitting Chain Member 11.

FIG. 29 shows a top-view of Torque Transmitting Chain Member 11.

FIG. 30 shows a rear-view of Link 12A.

FIG. 31 shows a side-view of Link 12A.

FIG. 32 shows a top-view of Link 12A.

FIG. 33 shows a rear-view of Link 12B.

FIG. 34 shows a side-view of Link 12B.

FIG. 35 shows a top-view of Link 12B.

FIG. 36 shows a side-view of Link 12C.

FIG. 37 shows a top-view of Link 12C.

FIG. 38 shows a rear-view of Leading End Non-Torque Transmitting Chain Member 13.

FIG. 39 shows a side-view of Leading End Non-Torque Transmitting Chain Member 13.

FIG. 40 shows a top-view of Leading End Non-Torque Transmitting Chain Member 13.

FIG. 41 shows a rear-view of Trailing End Link 14.

FIG. 42 shows a side-view of Trailing End Link 14.

FIG. 43 shows a top-view of Trailing End Link 14.

FIG. 44 shows a side-view of Non-Torque Transmitting Chain Member 15.

FIG. 45 shows a top-view of Non-Torque Transmitting Chain Member 15.

FIG. 46 shows a side-view of Non-Torque Transmitting Chain Member 16.

FIG. 47 shows a top-view of Non-Torque Transmitting Chain Member 16.

FIG. 48 shows a side-view of Leveling Loop 16.

FIG. 49 shows a sectional-view of Leveling Loop 16 as cut per FIG. 48.

FIG. 50 shows another sectional-view of Leveling Loop 16 as cut per FIG. 48.

FIG. 51 shows a side-view of a section of Leveling Loop 16 that is positioned between a section of Torque Transmitting Chain Member 9.

FIG. 52 shows a sectional-view of Leveling Loop 16 that is positioned between Torque Transmitting Chain Member 9 as cut per FIG. 51.

FIG. 53 shows another sectional-view of Leveling Loop 16 that is positioned between Torque Transmitting Chain Member 9 as cut per FIG. 51.

FIG. 54 shows a side-view of Leveling Loop 16A.

FIG. 55 shows a sectional-view of Leveling Loop 16A as cut per FIG. 54.

FIG. 56 shows another sectional-view of Leveling Loop 16A as cut per FIG. 54.

FIG. 57 shows the cross-section of Leveling Loop 16A of FIG. 56 on which a Chain Section (which is not labeled and not hatched) rests.

FIG. 58 shows a side-view of Leveling Loop 16B.

FIG. 59 shows a sectional-view of Leveling Loop 16B as cut per FIG. 58.

FIG. 60 shows another sectional-view of Leveling Loop 16B as cut per FIG. 58.

FIG. 61 shows the cross-section of Leveling Loop 16B of FIG. 60 that is positioned between a chain member.

FIG. 62 shows a rear-view of Reinforcement Plate 17.

FIG. 63 shows a side-view of Reinforcement Plate 17.

FIG. 64 shows a top-view of Reinforcement Plate 17.

FIG. 65 shows a rear-view of Reinforcement Plate 18.

FIG. 66 shows a side-view of Reinforcement Plate 18.

FIG. 67 shows a top-view of Reinforcement Plate 18.

FIG. 68 shows a side-view of Torque Transmitting Member 19.

FIG. 69 shows a sectional-view of Torque Transmitting Member Section 19-S1.

FIG. 70 shows another sectional-view of Torque Transmitting Member Section 19-S1.

FIG. 71 shows a rear-view of Leveling Extension 19-S2.

FIG. 72 shows a side-view of Non-Torque Transmitting Member 20.

FIG. 73 shows a sectional-view of Non-Torque Transmitting Member Section 20-S1.

FIG. 74 shows another sectional-view of Non-Torque Transmitting Member Section 20-S1.

FIG. 75 shows a rear-view of Leveling Extension 20-S2.

FIG. 76 shows a side-view Transmission Belt 21.

FIG. 77 shows a front-view Transmission Belt 21.

FIG. 78 shows a rear-view of Reinforcement Plate 22.

FIG. 79 shows a side-view of Reinforcement Plate 22.

FIG. 80 shows a top-view of Reinforcement Plate 22.

FIG. 81 shows a rear-view of Leading End Reinforcement Plate 22A.

FIG. 82 shows a side-view of Leading End Reinforcement Plate 22A.

FIG. 83 shows a top-view of Leading End Reinforcement Plate 22A.

FIG. 84 shows a rear-view of Trailing Sleeve Reinforcement Plate 22B.

FIG. 85 shows a side-view of Trailing Sleeve Reinforcement Plate 22B.

FIG. 86 shows a top-view of Trailing Sleeve Reinforcement Plate 22B.

FIG. 87 shows a rear-view of Trailing Sleeve Reinforcement Plate 22D.

FIG. 88 shows a side-view of Trailing Sleeve Reinforcement Plate 22D.

FIG. 89 shows a top-view of Trailing Sleeve Reinforcement Plate 22D.

FIG. 90 shows a rear-view of Trailing Sleeve Reinforcement Plate 22E.

FIG. 91 shows a side-view of Trailing Sleeve Reinforcement Plate 22E.

FIG. 92 shows a top-view of Trailing Sleeve Reinforcement Plate 22E.

FIG. 93 shows a rear-view of Trailing End Reinforcement Plate 22C.

FIG. 94 shows a side-view of Trailing End Reinforcement Plate 22C.

FIG. 95 shows a top-view of Trailing End Reinforcement Plate 22C.

FIG. 96 shows a side-view of Torque Transmitting Member 23.

FIG. 97 shows a top-view of Torque Transmitting Member 23.

FIG. 98 shows a sectional-view of Torque Transmitting Member Section 23-M1.

FIG. 99 shows a partial sectional-view of Torque Transmitting Member Section 23-M1.

FIG. 100 shows another sectional-view of Torque Transmitting Member Section 23-M1.

FIG. 101 shows a rear-view of Leveling Extension 23-M2.

FIG. 102 shows a rear-view of Reinforcement Plate 25-M1 and a Reinforcement Plate 25-M2.

FIG. 103 shows a side-view of Reinforcement Plate 25-M1.

FIG. 104 shows a side-view of Reinforcement Plate 25-M2.

FIG. 105 shows a top-view of Reinforcement Plate 25-M1 and a Reinforcement Plate 25-M2.

FIG. 106 shows a rear-view of Leading End Reinforcement Plate 25A.

FIG. 107 shows a side-view of Leading End Reinforcement Plate 25A.

FIG. 108 shows a top-view of Leading End Reinforcement Plate 25A.

FIG. 109 shows a rear-view of Trailing Sleeve Reinforcement Plate 25B.

FIG. 110 shows a side-view of Trailing Sleeve Reinforcement Plate 25B.

FIG. 111 shows a top-view of Trailing Sleeve Reinforcement Plate 25B.

FIG. 112 shows a rear-view of Trailing End Reinforcement Plate 25C.

FIG. 113 shows a side-view of Trailing End Reinforcement Plate 25C.

FIG. 114 shows a top-view of Trailing End Reinforcement Plate 25C.

FIG. 115 shows a side-view of Non-Torque Transmitting Member 26.

FIG. 116 shows a top-view of Non-Torque Transmitting Member 26.

FIG. 117 shows a sectional-view of Non-Torque Transmitting Member Section 26-M1.

FIG. 118 shows another sectional-view of Non-Torque Transmitting Member Section 26-M1.

FIG. 119 shows another sectional-view of Non-Torque Transmitting Member Section 26-M1.

FIG. 120 shows a rear-view of Leveling Extension 26-M2.

FIG. 121 shows the sectional-view of FIG. 118 with the Leveling Extension of its Torque Transmitting Member (which is labeled as Leveling Extension 23-M2) and its Transmission Belt 21.

FIG. 122 shows the sectional-view of FIG. 119 with its Transmission Belt 21.

FIG. 123 shows a rear-view of a Telescoping Leveling Extension that comprises of Leveling Extension 28 and Leveling Extension 29.

FIG. 124 shows a partial-side-view of a Telescoping Leveling Extension that comprises of Leveling Extension 28 and Leveling Extension 29. Some hidden lines of said partial-side-view are not shown.

FIG. 125 shows a partial top-view of a Telescoping Leveling Extension that comprises of Leveling Extension 28 and Leveling Extension 29. Some hidden lines of said partial-top-view are not shown.

FIG. 126 shows a rear-view of Leveling Extension 28.

FIG. 127 shows a partial-side-view of Leveling Extension 28. Some hidden lines of said partial-side-view are not shown.

FIG. 128 shows a partial-top-view of Leveling Extension 28. Some hidden lines of said partial-top-side-view are not shown.

FIG. 129 shows a rear-view of Leveling Extension 29.

FIG. 130 shows a partial-side-view of Leveling Extension 29. Some hidden lines of said partial-side-view are not shown.

FIG. 131 shows a partial-top-view of Leveling Extension 29. Some hidden lines of said partial-top-side-view are not shown.

FIG. 132 shows a Torque Transmitting Member 23A.

FIG. 133 shows a Non-Torque Transmitting Member 26A.

FIG. 134 shows a side-view of a Cone 31.

FIG. 135 shows a front-view of a Cone 31.

FIG. 136 shows a sectional-view of a Cone 31.

FIG. 137 shows a rear-view of Dome 32.

FIG. 138 shows a side-view of Dome 32.

FIG. 139 shows a top-view of Dome 32.

FIG. 140 shows a rear-view of a Leveling Extension 35.

FIG. 141 shows a sectional-view of a Torque Transmitting Member Section 23A-M1.

FIG. 142 shows a sectional-view of a Non-Torque Transmitting Member 26A-M1.

FIG. 143 shows a sectional-view of a Leveling Extension 36.

FIG. 144 shows a side-view of a Leveling Extension 36.

FIG. 145 shows a cross-section of Torque Transmitting Member Section 23A-M1, its Transmission Belt 21, and the Leveling Extension 36 inserted into it.

FIG. 146 shows a sectional-view of a Transmission Belt 21A and a Leveling Extension 36A.

FIG. 147 shows a side-view of a Transmission Belt 21A and a Leveling Extension 36A.

FIG. 148 shows a rear-view of Tooth 37 that has a Cut 37-S1.

FIG. 149 shows a sectional-view of a Transmission Belt 21B and a Leveling Extension 36B.

FIG. 150 shows a side-view of a Transmission Belt 21B and a Leveling Extension 36B.

FIG. 151 shows a rear-view of Tooth 37A that has a Cut 37A-S1.

FIG. 152 shows a side-view of a Support Wheel 38 that helps maintain the alignment of a Leveling Extension 36C.

FIG. 153 shows a sectional-view of Torque Transmitting Member Section Rear End 40.

FIG. 154 shows a side-view of Torque Transmitting Member Section Rear End 40.

FIG. 155 shows a top-view of Torque Transmitting Member Section Rear End 40.

FIG. 156 shows a side-view of Torque Transmitting Member Section Rear End 40A.

FIG. 157 shows a sectional-view of Non-Torque Transmitting Member Section Rear End 42.

FIG. 158 shows a side-view of Non-Torque Transmitting Member Section Rear End 42.

FIG. 159 shows a top-view of Non-Torque Transmitting Member Section Rear End 42.

FIG. 160 shows a rear-view of Link 43A.

FIG. 161 shows a side-view of Link 43A.

FIG. 162 shows a top-view of Link 43A.

FIG. 163 shows a rear-view of Link 43B.

FIG. 164 shows a side-view of Link 43B.

FIG. 165 shows a top-view of Link 43B.

FIG. 166 shows a rear-view of Leading End Torque Transmitting Chain Member 44.

FIG. 167 shows a side-view of Leading End Torque Transmitting Chain Member 44.

FIG. 168 shows a top-view of Leading End Torque Transmitting Chain Member 44.

FIG. 169 shows a rear-view of Trailing End Link 45.

FIG. 170 shows a side-view of Trailing End Link 45.

FIG. 171 shows a top-view of Trailing End Link 45.

FIG. 172 shows a side-view of Torque Transmitting Chain Member 46.

FIG. 173 shows a top-view of Torque Transmitting Chain Member 46.

FIG. 174 shows a rear-view of Link 47.

FIG. 175 shows a side-view of Link 47.

FIG. 176 shows a top-view of Link 47.

FIG. 177 shows a side-view of Leveling Loop 48.

FIG. 178 shows a sectional-view of Leveling Loop 48 as cut per FIG. 177.

FIG. 179 shows another sectional-view of Leveling Loop 48 as cut per FIG. 177.

FIG. 180 shows a Leg of a Leveling Loop.

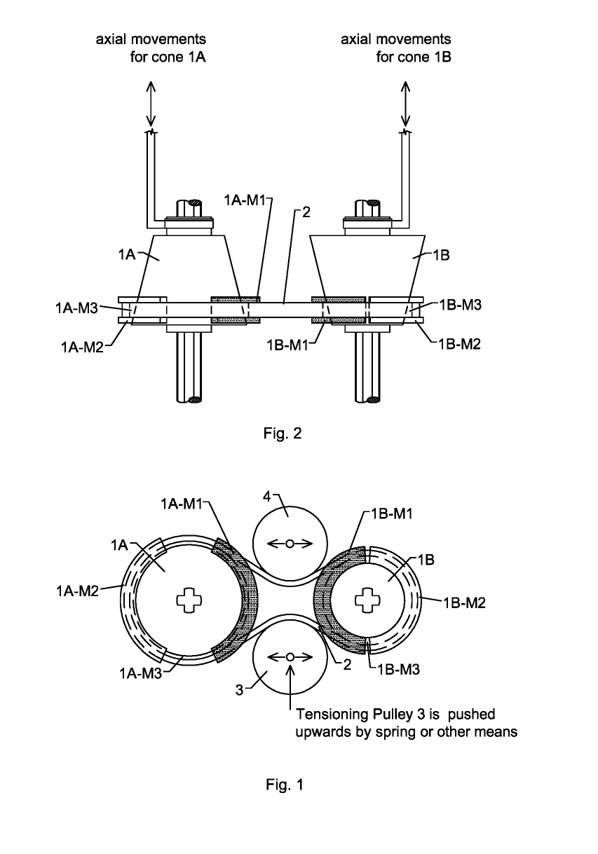

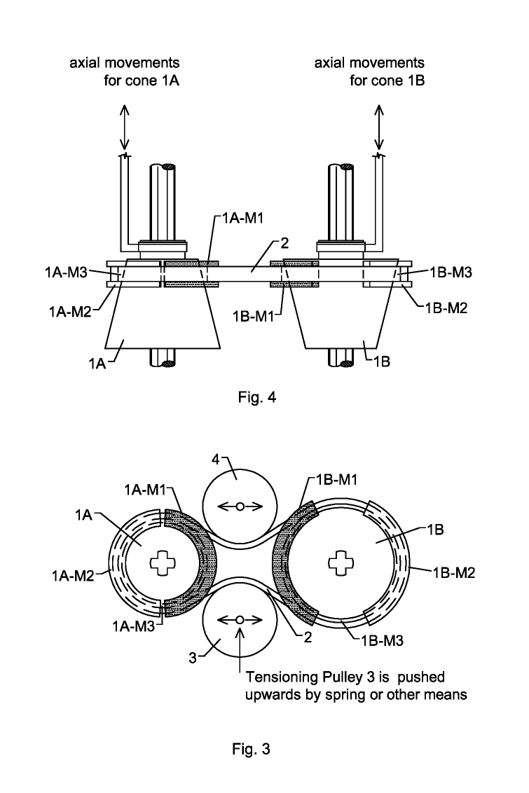

### REFERENCE NUMERALS IN DRAWINGS

For the reference numerals in this disclosure, the label M(number) after a reference numeral, where (number) is a number, such as M2 for example, is used to label different members of a part that is given one reference numeral but consist of more than one member. And the label S(number) after a reference numeral, where (number) is a number, such as S2 for example, is used to label the different shapes of a part that is given one reference numeral. Furthermore, same parts that are used in different location might have a different labeling letter after their reference numeral, or a different reference numeral altogether if this is helpful in describing the invention. If two parts have the same reference numeral then they are identical unless otherwise described.

### DETAILED DESCRIPTION OF THE INVENTION

### Torque Transmitting Chain Member, Non-Torque Transmitting Chain Member, and Leveling Loop For a Uniformed Surfaced Cone

In this section, a Torque Transmitting Chain Member, Non-Torque Transmitting Chain Member, and Leveling Loop for a Uniformed Surfaced Cone is described.

The Torque Transmitting Chain Member of this section is mainly formed by alternating Links 6A and 6B that are held together by Pins or Joiner Plates 5.

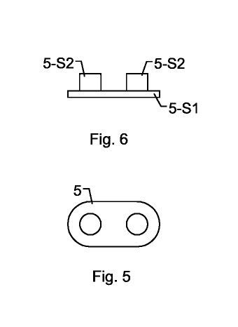

A Joiner Plate 5, which is shown in FIGS. 5 to 6, is a Plate 5-S1 that has two Pins 5-S2. Pins 5-S2 have the same function as a regular Pins that used for joining links of a chain. Unlike a regular chain, a Torque Transmitting Chain Member preferably has a high lateral stiffness; the purpose of Plate 5-S1 is to increase its lateral stiffness of its Torque Transmitting Chain Member.

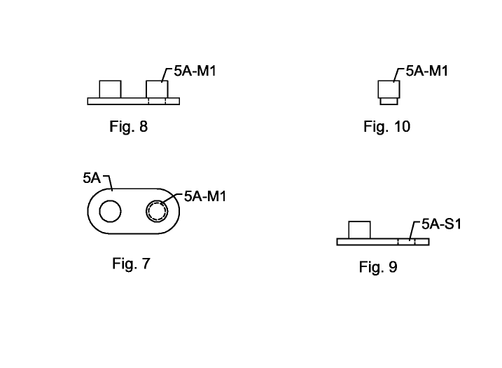

FIGS. 7 to 8 show an alternate Joiner Plate, which is labeled as Joiner Plate 5A. For Joiner Plate 5A one pin is removable; the removable pin is labeled as Pin 5A-M1. FIG. 9 shows Joiner Plate 5A for which its Pin 5A-M1 has been removed; and FIG. 10 shows the removed Pin 5A-M1. The designated hole for Pin 5A-M1 of an Joiner Plate 5A, which in FIG. 9 is labeled as Hole 5A-S1, should be small enough so that Pin 5A-S1 can be tightly and securely inserted into it. Joiner Plate 5A can be used to reduce the distance between the sleeves of a Leading End Torque Transmitting Member, which will be described below.

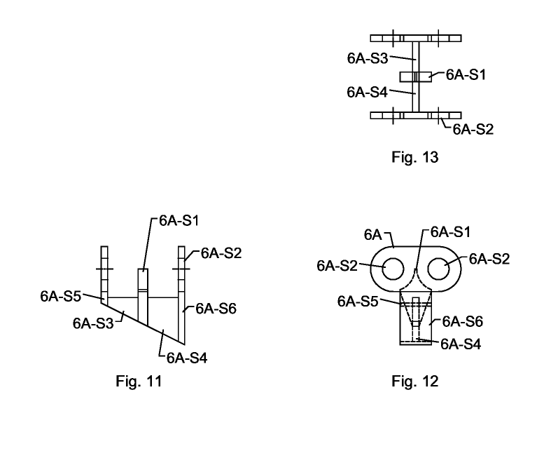

A Link 6A is shown in FIGS. 11 to 13. Link 6A has a Tooth 6A-S1, four Holes 6A-S2 (two on each side), a Tooth-to-Side Connector 6A-S3, a Tooth-to-Side Connector 6A-S4, a Side Connector-Extension 6A-S5, and a Side Connector-Extension 6A-S6.

Tooth-to-Side Connector 6A-S3 and Tooth-to-Side Connector 6A-S4 are used to connect Tooth 6A-S1 to the sides of Link 6A, through Side Connector-Extension 6A-S5, and Side Connector-Extension 6A-S6 (see FIGS. 11 to 12).

Link 6A has two “narrow inner base portions”. One “narrow inner base portion” is formed by Tooth-to-Side Connector 6A-S3, and the other “narrow inner base portion” is for formed by Tooth-to-Side Connector 6A-S4 (see FIG. 13). These “narrow inner base portions” allow for a resting places on the surface of a cone for sections of a leveling loop. If desired instead of a Link 6A, a link with more or less “narrow inner base portions” can be used, as long as the link has at least one “narrow inner base portion” that allows for a resting place on the surface of a cone for a section of a leveling loop.

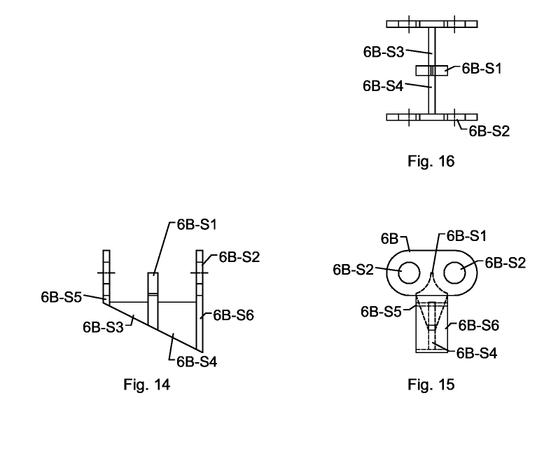

Link 6B is basically identical to Link 6A except that it is wider. A Link 6B is shown in FIGS. 14 to 16. Link 6B has a Tooth 6B-S1, four Holes 6B-S2 (two on each side), a Tooth-to-Side Connector 6B-S3, a Tooth-to-Side Connector 6B-S4, a Side Connector-Extension 6B-S5, and a Side Connector-Extension 6B-S6.

Tooth-to-Side Connector 6B-S3 and Tooth-to-Side Connector 6B-S4 are used to connect Tooth 6B-S1 to the sides of Link 6B, through Side Connector-Extension 6B-S5, and Side Connector-Extension 6B-S6 (see FIGS. 14 to 15).

Link 6B has two “narrow inner base portions”. One “narrow inner base portion” is formed by Tooth-to-Side Connector 6B-S3, and the other “narrow inner base portion” is for formed by Tooth-to-Side Connector 6B-S4 (see FIG. 16). These “narrow inner base portions” allow for a resting places on the surface of a cone for sections of a leveling loop. If desired instead of a Link 6B, a link with more or less “narrow inner base portions” can be used, as long as the link has at least one “narrow inner base portion” that allows for a resting place on the surface of a cone for a section of a leveling loop.

In order to attach the leading-end of a Torque Transmitting Chain Member of this section to a “cone with one torque transmitting member” that is referred to as a front pin belt cone assembly 520A in U.S. Pat. No. 8,628,439 (refer to column 90 line 64 to column 99 line 11; and FIGS. 91A, 91B, 92A, 92B, 93 to 101 of U.S. Pat. No. 8,628,439), a Leading End Torque Transmitting Chain Member 7 will be used.

And in order to secure the trailing-end of a Torque Transmitting Chain Member of this section to a “cone with one torque transmitting member”, a Trailing End Link 8 will be used.

And in order to connect a Trailing End Slide (which is used to move and maintain the axial alignment of the trailing-end portion of a Torque Transmitting Chain Member) to a Torque Transmitting Chain Member, a Trailing End Joiner Plate 5B will be used.

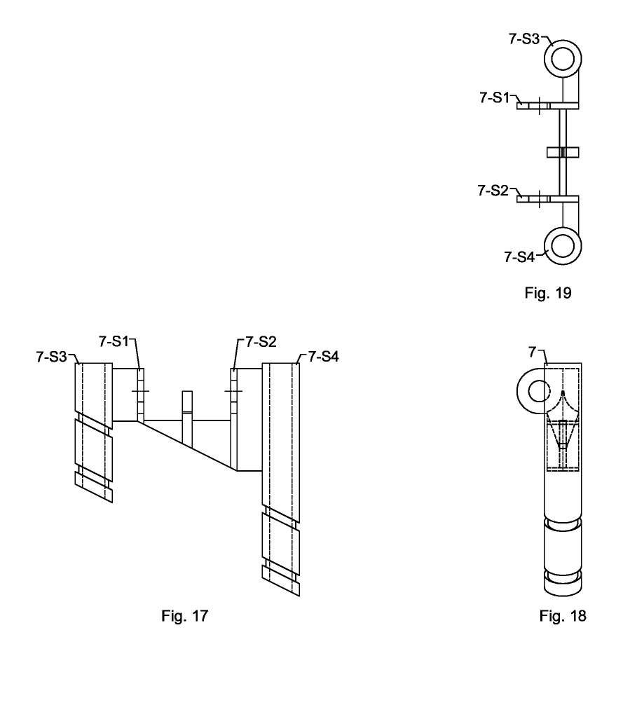

FIGS. 17 to 19 show Leading End Torque Transmitting Chain Member 7. Leading End Torque Transmitting Chain Member 7 is identical to Link 6B, except for its sides, which are labeled as Side 7-S1 and Side 7-S2. Unlike Link 6B, the sides of Leading End Torque Transmitting Chain Member 7 are shorter and as such have only 1 hole each instead of two; and unlike the sides of Link 6B, the sides of Leading End Torque Transmitting Chain Member 7 have Attachment Sleeves attached to them; these Attachment Sleeves are labeled as Attachment Sleeves 7-S3 and 7-S4.

Depending on the alternating-links arrangement of the Torque Transmitting Chain Member, in some configuration (such as Link 6B to Link 6A to Link 6B, instead of Link 6A to Link 6B to Link 6A for example), a Leading End Torque Transmitting Chain Member that is identical as described in the previous paragraph, except that its partial Link 6B portion is replaced with a partial Link 6A portion, has to be used.

Attachment Sleeves 7-S3 and 7-S4 are used to attach Leading End Torque Transmitting Chain Member 7 of a Torque Transmitting Chain Member to a torque transmitting member carriage 550A of a front pin belt cone assembly 520A of U.S. Pat. No. 8,628,439; using the same method that the sleeves of a leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

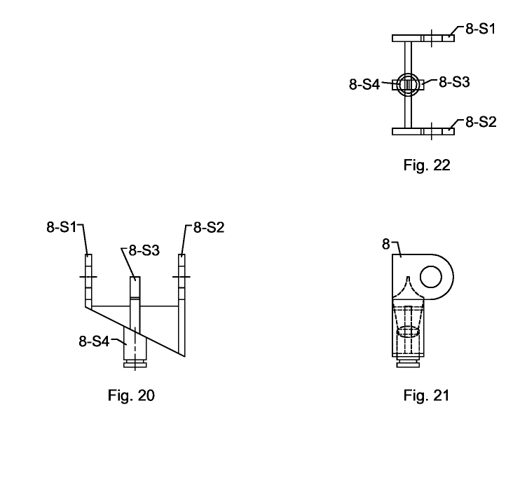

FIGS. 20 to 22 show Trailing End Link 8. Trailing End Link 8 is identical to Link 6B, except for: a) its sides, which are labeled as Side 8-S1 and Side 8-S2. Unlike Link 6B, the sides of Trailing End Link 8 are shorter and as such have only 1 hole each instead of two.

And b) unlike Link 6B, Trailing End Link 8 has a Slot Engagement Pin 8-S4, and the base of its tooth (which is labeled as Tooth 8-S3) is wider than the base of the tooth of Link 6B (which is labeled as Tooth 6B-S1) in order to better accommodate Slot Engagement Pin 8-S4.

Trailing End Link 8 is used as the trailing end link of its Torque Transmitting Chain Member, and Slot Engagement Pin 8-S4 is used to secure the trailing end of its Torque Transmitting Chain Member to its cone.

Depending on the alternating-links arrangement of the Torque Transmitting Chain Member, in some configuration (such as Link 6B to Link 6A to Link 6B, instead of Link 6A to Link 6B to Link 6A for example), a Trailing End Link 8 that is identical as described in the previous paragraph, except that its partial Link 6B portion is replaced with a partial Link 6A portion, has to be used.

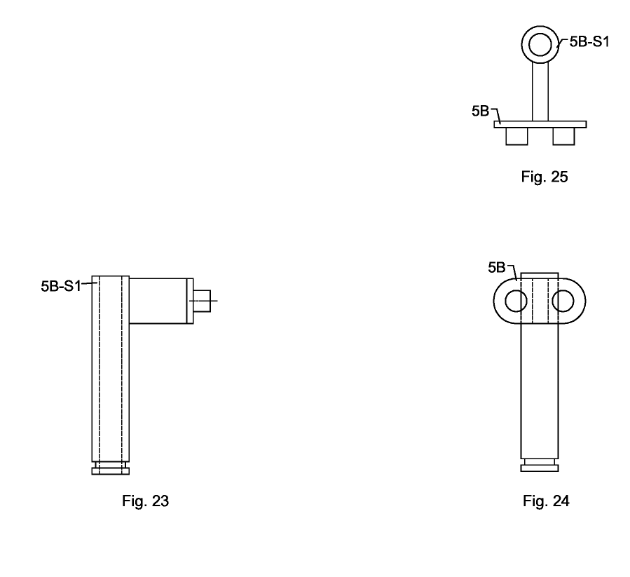

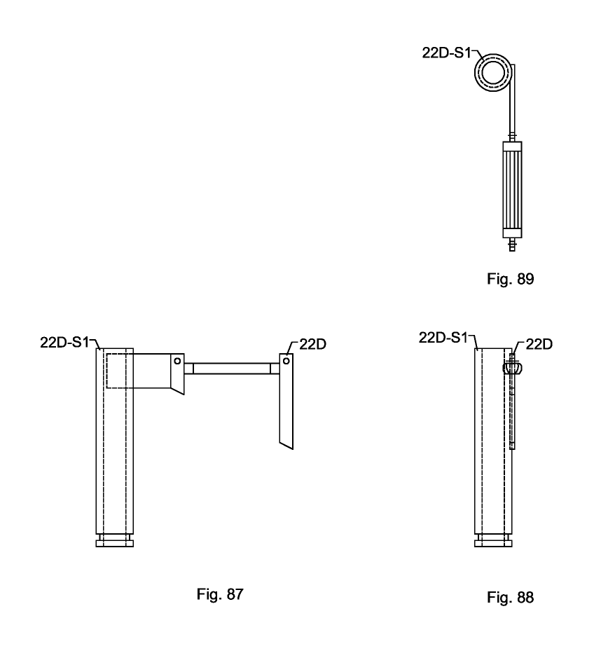

FIGS. 23 to 25 show a Trailing End Joiner Plate 5B. Trailing End Joiner Plate 5B is identical to Joiner Plate 5, except that the outer surface of Trailing End Joiner Plate 5B has an Attachment Sleeve, which is labeled as Attachment Sleeve 5B-S1, attached to it. Trailing End Joiner Plate 5B should be positioned on the larger cone dimeter resting side of its Torque Transmitting Chain Member. If necessary for alignment with Slot Engagement Pin 8-S4 in their Trailing End Cut (see below for details), Attachment Sleeve 5B-S1 can be positioned to the left or to the right from the position shown in FIGS. 24 and 25 (Attachment Sleeve 5B-S1 does not have to be positioned at the mid-length of Trailing End Joiner Plate 5B as shown). An analogous comparison for this for a Torque Transmitting Member 23 is that Attachment Sleeve 22B-S1 can be positioned behind (to the left) or in-front (to the right) of its Reinforcement Plate (see FIGS. 87 to 92).

Attachment Sleeve 5B-S1 is used to connect the trailing end portion of a Torque Transmitting Chain Member to a Trailing End Slide (which is used to move and maintain the axial alignment of the trailing-end-portion of a Torque Transmitting Chain Member) of its cone; using the same method that trailing plate sleeve 593-S1 of a pin belt torque transmitting member 590 is connected to a trailing end slide 565-S1 of its front pin belt cone assembly 520A of U.S. Pat. No. 8,628,439 (refer to column 92 line 54 to column 93 line 32 of U.S. Pat. No. 8,628,439).

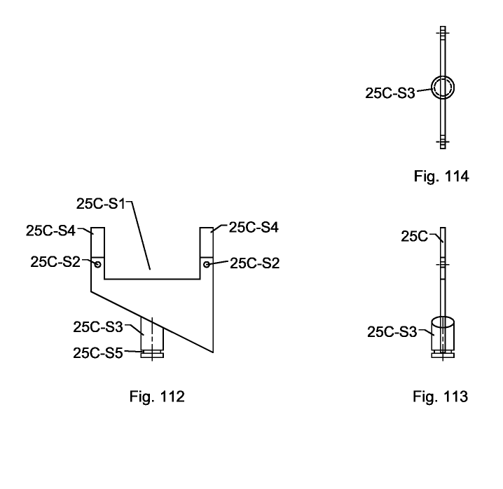

A Torque Transmitting Chain Member should be designed so that its Slot Engagement Pin 8-S4 and its Attachment Sleeve 5B-S1 can slide in the same Trailing End Cut (the Trailing End Cuts for a cone are shown and labeled as trailing end cuts 540-S6 in FIG. 112B of U.S. Pat. No. 8,628,439), in a manner so that Slot Engagement Pin 8-S4 can engage with its Trailing End Cut surface that prevents its Torque Transmitting Chain Member from moving towards its Leading End Cut, so that Slot Engagement Pin 8-S4 can transfer torque in the direction that pulls from the Trailing End towards the Leading End of its cone; and preferably (but not necessarily) also prevents its Torque Transmitting Chain Member from moving away from its Leading End. If necessary, some play between Attachment Sleeve 5B-S1 and its Trailing End Cut is allowed. And if there are interferences between the fastener for Slot Engagement Pin 8-S4 and the fastener for Attachment Sleeve 5B-S1, then it is not necessary to use the fastener of Attachment Sleeve 5B-S1.

The Leading End Cuts for a cone are shown and labeled as leading end cuts 540-S1 in FIG. 112B of U.S. Pat. No. 8,628,439. The Leading End Cuts are used to insert the Attachment Sleeves of a Leading End Torque Transmitting Chain Member.

The proper location of Attachment Sleeve 5B-S1 relative to Slot Engagement Pin 8-S4, as well as the shape and size of all cuts on a cone can be determined through trial-and-error and experimentation (such as tracing for example).

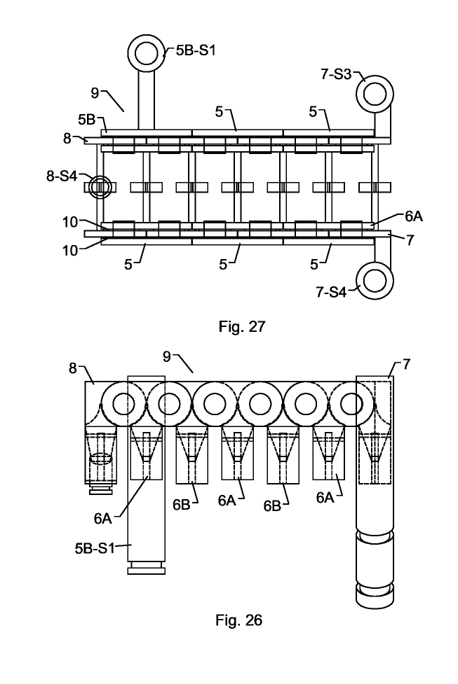

FIGS. 26 to 27, show a Torque Transmitting Chain Member of this section. This Torque Transmitting Chain Member, which is labeled as Torque Transmitting Chain Member 9, comprises of a Leading End Torque Transmitting Chain Member 7, alternating Links 6A and Links 6B, and a Trailing End Link 8 that are linked together by Joiner Plates 5 and a Trailing End Joiner Plate 5B.

The Joiner Plates 5 have Pins 5-S2 (see FIG. 6), and each Pin 5-S2 is inserted through the holes of two adjacent links (here the links are: Leading End Torque Transmitting Chain Member 7, Links 6A, Links 6B, and Trailing End Link 8), so as to link them together. In FIGS. 26 to 27, each Pin 5-S2 is secured due to the friction between it and its hole of a Link 6A; because of this, it is recommended that the holes of Links 6A are smaller than the holes of the other links. Trailing End Joiner Plate 5B is identical to Joiner Plates 5, except that it also has an Attachment Sleeve 5B-S1.

In order to reduce friction, Washers 10, which should be made out of a low friction material, can be placed between all engaging side surfaces of two links, and between all engaging side surfaces of a link with a Joiner Plates 5 or Trailing End Joiner Plate 5B; however, this is not absolutely necessary, since the chain member can be used where it is submerged or coated in lubricants.

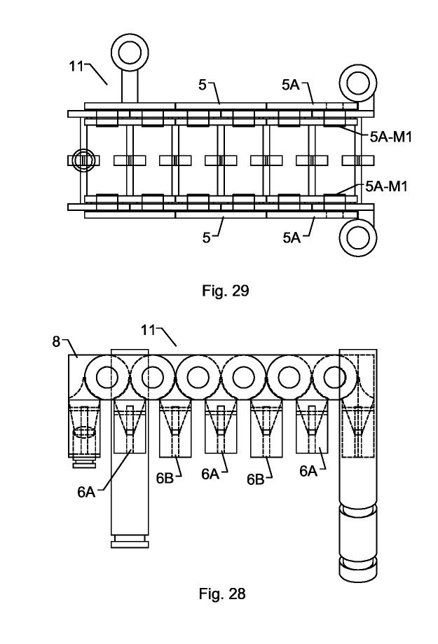

For Leading End Torque Transmitting Chain Member 7, the distance between Attachment Sleeves 7-S3 and 7-S4 can be reduced by using Joiner Plates 5A instead of Joiner Plates 5 in order to connect Leading End Torque Transmitting Chain Member 7 to its Link 6A (Joiner Plate 5A was described earlier and shown in FIGS. 7 to 10). Here the removable-pin-ends of Joiner Plates 5A can be linked to Leading End Torque Transmitting Chain Member 7 and a Link 6A, by placing Joiner Plates 5A on both outside surfaces of Leading End Torque Transmitting Chain Member 7 in such a manner such that Pins 5A-M1 can be pressed-in through the exposed-end holes of said Link 6A, the holes of Leading End Torque Transmitting Chain Member 7, and the Holes 5A-S1 of Joiner Plate 5A, and then securely pressing in the Pins 5A-M1. If this is desired, then for FIG. 27, the Joiner Plates 5 that are used to connect Leading End Torque Transmitting Chain Member 7 to its Link 6A have to be replaced with Joiner Plates 5A accordingly. FIGS. 28 to 29 show a Torque Transmitting Chain Member 11 for which the distance between the Attachment Sleeves of the Leading End Torque Transmitting Chain Member are reduced through the use of Joiner Plates 5A.

The Non-Torque Transmitting Chain Member of this section is mainly formed by alternating Links 12A and 12B that are held together by Pins or Joiner Plates 5.

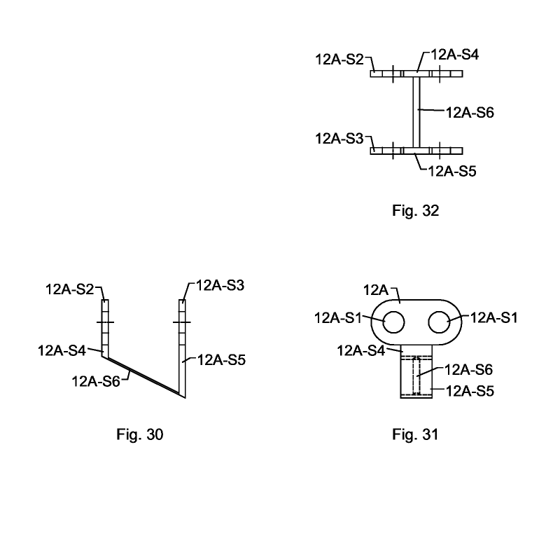

A Link 12A is shown in FIGS. 30 to 32. Link 12A is basically identical to Link 6A, except that it doesn't have Tooth 6A-S1, a Tooth-to-Side Connector 6A-S3, and a Tooth-to-Side Connector 6A-S4; in addition, unlike Link 6A, Link 11A has a Base 12A-S6.

A Link 12A has a Side 12A-S2 and a Side 12-S3, which each have two holes 12A-S1. Side 12A-S2 and Side 12-S3 are connected by Base 12A-S6 through Side Connector-Extension 12A-S4 and Side Connector-Extension 12A-S5, which extend below Side 12A-S2 and Side 12-S3 and are narrower than said Sides in order to allow for sufficient bending of its Non-Torque Transmitting Chain Member

Base 12A-S6 of Link 12A is very narrow; this allows for a resting place for a section of a leveling loop. In addition, Base 12A-S6 is shaped so that the “cone surface resting base” of its leveling loop can slide over it during transmission ratio change.

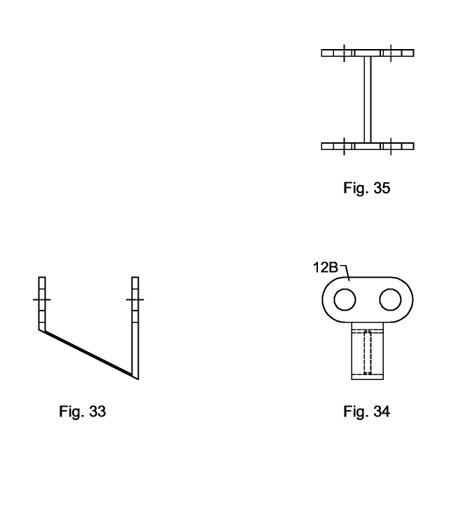

A Link 12B is shown in FIGS. 33 to 35. Link 12B is basically identical to Link 12A except that it is wider.

Furthermore, in order to prevent excessive vibration due to centrifugal forces, it is recommended that each link of a Torque Transmitting Chain Member has the same weight as the corresponding (oppositely positioned) link of its Non-Torque Transmitting Chain Member; so that the centrifugal forces of the Chain Members cancel each other out. This can be ensured through the selection of material or by adding weight increasing shapes to the links of the Non-Torque Transmitting Chain Member if necessary.

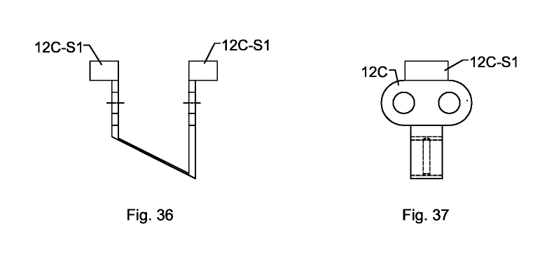

FIGS. 36 to 37 show a link of a Non-Torque Transmitting Chain Member to which balancing weights have been added, so that the weight of this link is identical to the weight of the corresponding link of its Torque Transmitting Chain Member. This link is labeled as Link 12C, and it is basically identical to Link 12A, except that it has Balancing Weights 12C-S1. In a similar manner, Link 41B can also be modified in order to have Balancing Weights.

In order to attach the leading-end of a Non-Torque Transmitting Chain Member of this section to a “cone with one torque transmitting member” that is referred to as a front pin belt cone assembly 520A in U.S. Pat. No. 8,628,439 (refer to column 90 line 64 to column 99 line 11; and FIGS. 91A, 91B, 92A, 92B, 93 to 101 of U.S. Pat. No. 8,628,439), a Leading End Non-Torque Transmitting Chain Member 13 will be used.

And in order to secure the trailing-end of a Non-Torque Transmitting Chain Member of this section to a “cone with one torque transmitting member”, a Trailing End Link 14 will be used.

And in order to connect a Trailing End Slide (which is used to move and maintain the axial alignment of the trailing-end portion of a Non-Torque Transmitting Chain Member) to a Torque Transmitting Chain Member, a Trailing End Joiner Plate 5B will be used.

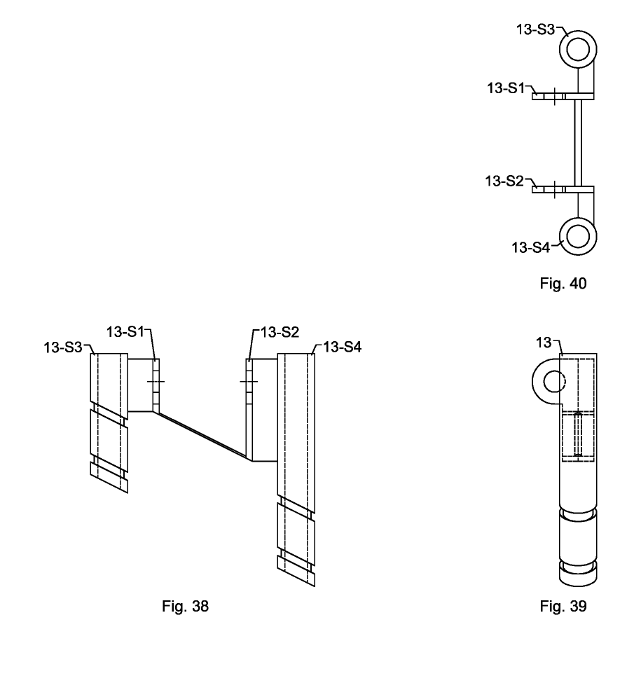

FIGS. 38 to 40 show Leading End Non-Torque Transmitting Chain Member 13. Leading End Non-Torque Transmitting Chain Member 13 is identical to Link 12B, except for its sides, which are labeled as Side 13-S1 and Side 13-S2. Unlike Link 12B, the sides of Leading End Non-Torque Transmitting Chain Member 13 are shorter and as such have only 1 hole each instead of two; and unlike the sides of Link 12B, the sides of Leading End Non-Torque Transmitting Chain Member 13 have Attachment Sleeves attached to them; these Attachment Sleeves are labeled as Attachment Sleeves 13-S3 and 13-S4.

Depending on the alternating-links arrangement of the Non-Torque Transmitting Chain Member, in some configuration (such as Link 12B to Link 12A to Link 12B, instead of Link 12A to Link 12B to Link 12A for example), a Leading End Non-Torque Transmitting Chain Member that is identical as described in the previous paragraph, except that its partial Link 12B portion is replaced with a partial Link 12A portion, has to be used.

Attachment Sleeves 13-S3 and 13-S4 are used to attach Leading End Non-Torque Transmitting Chain Member 13 of a Non-Torque Transmitting Chain Member to a torque transmitting member carriage 550A of a front pin belt cone assembly 520A of U.S. Pat. No. 8,628,439; using the same method that the sleeves of a leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

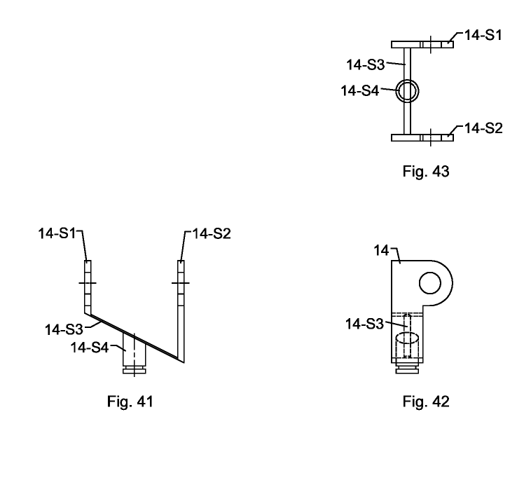

FIGS. 41 to 43 show Trailing End Link 14. Trailing End Link 14 is identical to Link 12B, except for: a) its sides, which are labeled as Side 14-S1 and Side 14-S2. Unlike Link 12B, the sides of Trailing End Link 14 are shorter and as such have only 1 hole each instead of two.

And b) unlike Link 12B, Trailing End Link 14 has a Slot Engagement Pin 14-S4 attached its base. The base of Trailing End Link 14 is labeled as Base 14-S3.

Trailing End Link 14 is used as the trailing end link of its Non-Torque Transmitting Chain Member, and Slot Engagement Pin 14-S4 is used to secure the trailing end of its Non-Torque Transmitting Chain Member to its cone.

Depending on the alternating-links arrangement of the Non-Torque Transmitting Chain Member, in some configuration (such as Link 6B to Link 6A to Link 6B, instead of Link 6A to Link 6B to Link 6A for example), a Trailing End Link 14 that is identical as described in the previous paragraph, except that its partial Link 12B portion is replaced with a partial Link 12A portion, has to be used.

FIGS. 23 to 25 show a Trailing End Joiner Plate 5B (which was described previously for a Torque Transmitting Chain Member). Trailing End Joiner Plate 5B is identical to Joiner Plate 5, except that the outer surface of Trailing End Joiner Plate 5B has an Attachment Sleeve, which is labeled as Attachment Sleeve 5B-S1, attached to it. Trailing End Joiner Plate 5B should be positioned on the larger cone dimeter resting side of its Non-Torque Transmitting Chain Member. If necessary for alignment with Slot Engagement Pin 14-S4 in their Trailing End Cut (see paragraphs below for details), Attachment Sleeve 5B-S1 can be positioned to the left or to the right from the position shown in FIGS. 24 and 25 (Attachment Sleeve 5B-S1 does not have to be positioned at the mid-length of Trailing End Joiner Plate 5B as shown).

Attachment Sleeve 5B-S1 is used to connect the trailing end portion of a Non-Torque Transmitting Chain Member to a Trailing End Slide (which is used to move and maintain the axial alignment of the trailing-end-portion of a Non-Torque Transmitting Chain Member) of its cone; using the same method that trailing plate sleeve 593-S1 of a pin belt torque transmitting member 590 is connected to a trailing end slide 565-S1 of its front pin belt cone assembly 520A of U.S. Pat. No. 8,628,439 (refer to column 92 line 54 to column 93 line 32 of U.S. Pat. No. 8,628,439).

A Non-Torque Transmitting Chain Member should be designed so that its Slot Engagement Pin 14-S4 and its Attachment Sleeve 5B-S1 can slide in the same Trailing End Cut (the Trailing End Cuts for a cone are shown and labeled as trailing end cuts 540-S6 in FIG. 112B of U.S. Pat. No. 8,628,439), in a manner so that Slot Engagement Pin 14-S4 can engage with its Trailing End Cut surface that prevents its Non-Torque Transmitting Chain Member from moving towards its Leading End Cut, so that Slot Engagement Pin 14-S4 can transfer torque in the direction that pulls from the Trailing End towards the Leading End of its cone; and preferably (but not necessarily) also prevents its Non-Torque Transmitting Chain Member from moving away from its Leading End. If necessary, some play between Attachment Sleeve 5B-S1 and its Trailing End Cut is allowed. And if there are interferences between the fastener for Slot Engagement Pin 14-S4 and the fastener for Attachment Sleeve 5B-S1, then it is not necessary to use the fastener of Attachment Sleeve 5B-S1.

The Leading End Cuts for a cone are shown and labeled as leading end cuts 540-S1 in FIG. 112B of U.S. Pat. No. 8,628,439. The Leading End Cuts are used to insert the Attachment Sleeves of a Leading End Non-Torque Transmitting Chain Member.

The proper location of Attachment Sleeve 5B-S1 relative to Slot Engagement Pin 14-S4, as well as the shape and size of all cuts on a cone can be determined through trial-and-error and experimentation (such as tracing for example).

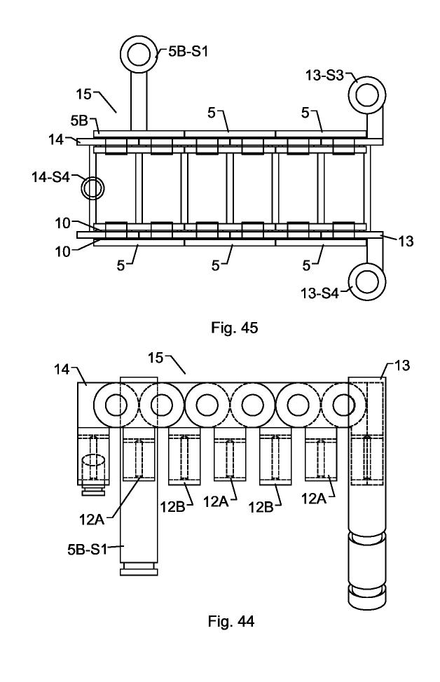

FIGS. 44 to 45, show a Non-Torque Transmitting Chain Member of this section. This Non-Torque Transmitting Chain Member, which is labeled as Non-Torque Transmitting Chain Member 15, comprises of a Leading End Non-Torque Transmitting Chain Member 13, alternating Links 12A and Links 12B, and a Trailing End Link 14 that are linked together by Joiner Plates 5 and a Trailing End Joiner Plate 5B.

The Joiner Plates 5 have Pins 5-S2 (see FIG. 6), and each Pin 5-S2 is inserted through the holes of two adjacent links (here the links are: Leading End Torque Transmitting Chain Member 13, Links 12A, Links 12B, and Trailing End Link 14), so as to link them together. In FIGS. 44 to 45, each Pin 5-S2 is secured due to the friction between it and its hole of a Link 12A; because of this, it is recommended that the holes of Links 12A are smaller than the holes of the other links. Trailing End Joiner Plate 5B is identical to Joiner Plates 5, except that it also has an Attachment Sleeve 5B-S1.

In order to reduce friction, Washers 10, which should be made out of a low friction material, can be placed between all engaging side surfaces of two links, and between all engaging side surfaces of a link with a Joiner Plates 5 or Trailing End Joiner Plate 5B; however, this is not absolutely necessary, since the chain member can be used where it is submerged or coated in lubricants.

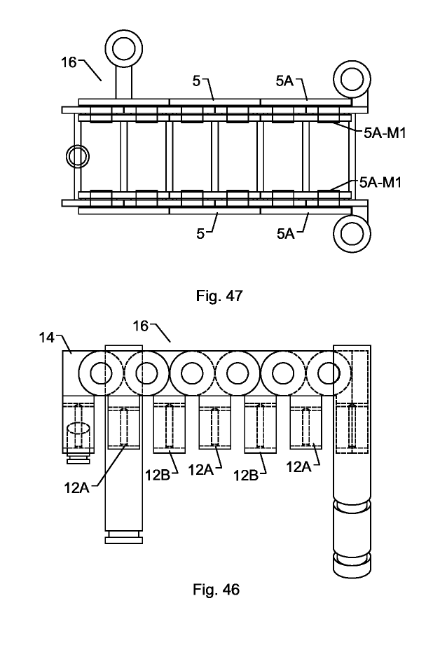

For Leading End Non-Torque Transmitting Chain Member 13, the distance between Attachment Sleeves 13-S3 and 13-S4 can be reduced by using Joiner Plates 5A instead of Joiner Plates 5 in order to connect Leading End Non-Torque Transmitting Chain Member 13 to its Link 12A (Joiner Plate 5A was described earlier and shown in FIGS. 7 to 10). Here the removable-pin-ends of Joiner Plates 5A can be linked to Leading End Non-Torque Transmitting Chain Member 13 and a Link 12A, by placing Joiner Plates 5A on both outside surfaces of Leading End Non-Torque Transmitting Chain Member 13 in such a manner such that Pins 5A-M1 can be pressed-in through the exposed-end holes of said Link 12A, the holes of Leading End Non-Torque Transmitting Chain Member 13, and the Holes 5A-S1 of Joiner Plate 5A, and then securely pressing in the Pins 5A-M1. If this is desired, then for FIG. 45, the Joiner Plates 5 that are used to connect Leading End Non-Torque Transmitting Chain Member 13 to its Link 12A have to be replaced with Joiner Plates 5A accordingly. FIGS. 46 to 47 show a Non-Torque Transmitting Chain Member 16 for which the distance between the Attachment Sleeves of the Leading End Torque Transmitting Chain Member are reduced through the use of Joiner Plates 5A.

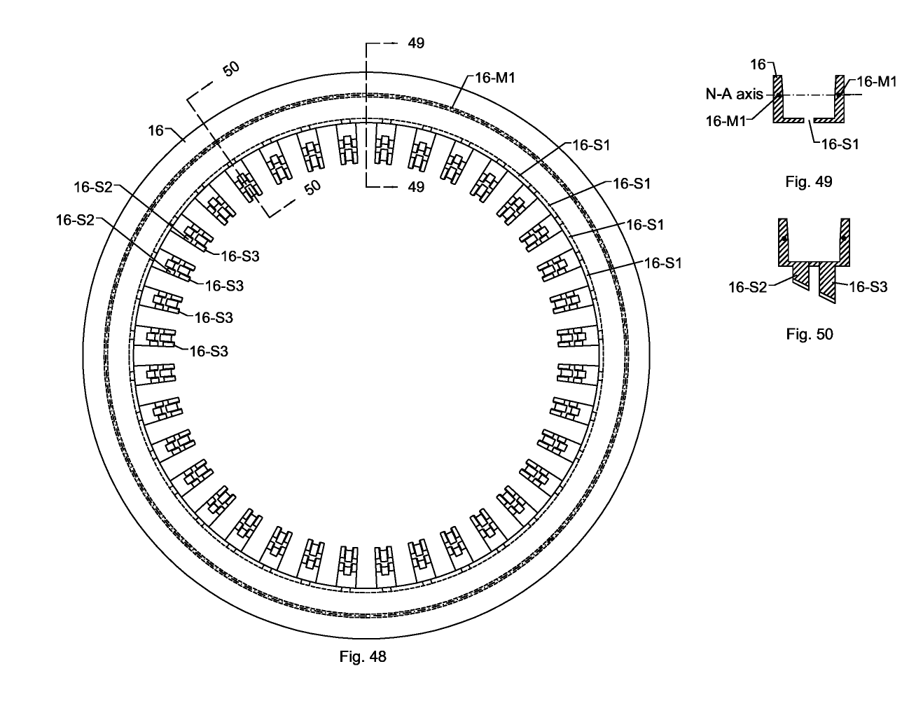

The Leveling Loop of this section is shown in FIGS. 48 to 50; it is labeled as Leveling Loop 16. The cross-section of Leveling Loop 16 is channel-shaped with two sides and a horizontal base (see FIG. 49); said horizontal base has cut-outs for teeth, which are labeled as Cut-outs 16-S1 (see FIGS. 48 and 49). It is recommended that Cut-outs 16-S1 are slightly wider than the width of the teeth of its Torque Transmitting Chain Member in order to allow for some leeway. The Cut-outs 16-S1 should have the “same” or “almost the same” pitch as the pitch of the teeth of its Torque Transmitting Chain Member for all transmission diameters of its cone. In order to ensure this, the Neutral-Axis of Leveling Loop 16 should “coincide” or “almost coincide” with the Bending-Axis of its Torque Transmitting Chain Member. It is recommended that Leveling Loop 16 has Reinforcements 16-M1. This will make it easier to place the Neutral-Axis of Leveling Loop 16, and this will increase the lateral stiffness of Leveling Loop 16.

In addition, Leveling Loop 16 also has Legs 16-S2 and Legs 16-S3 (see FIGS. 48 and 50). The “dimension of Legs 16-S2 and Legs 16-S3” and the “dimension of the links of its Chain Members (which are its Torque Transmitting Chain Member and its Non-Torque Transmitting Chain Member)” should be selected so that there is sufficient clearance for “Legs 16-S2 and Legs 16-S3” to smoothly enter and exit its Chain Members.

Furthermore, the bases of each “Leg 16-S2 and Leg 16-S3” has a groove at/near its mid-width. The grooves of each “Leg 16-S2 and Leg 16-S3” and the bases of each “Leg 16-S2 and Leg 16-S3” are shaped so that their “Leg 16-S2 and Leg 16-S3” can slide-over the bases of their Non-Torque Transmitting Chain Member when the diameter of their cone is changed, and so that the bases of their Non-Torque Transmitting Chain Member can enter and exit said grooves.

Said grooves are necessary since for each 1-tooth diameter change of a cone, the “Leveling Loop 16 section” between a Torque Transmitting Chain Member and a Non-Torque Transmitting Chain Member only slides ½-tooth length towards or away from said Non-Torque Transmitting Chain Member. This is because there are two said “Leveling Loop 16 sections” oppositely position on said cone, which lengths each change by the amount of ½-tooth length for each 1-tooth diameter increase of said cone. Here said “Leveling Loop 16 sections” refers to the oppositely positioned spaces between a Torque Transmitting Chain Member and a Non-Torque Transmitting Chain Member, which change in length as the transmission diameter of their cone is changed.

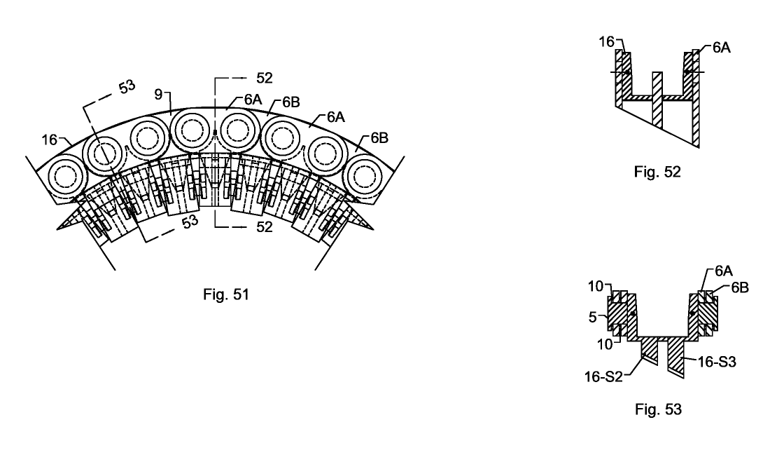

FIG. 51 shows a side-view of a section of Leveling Loop 16 that is positioned between a section of Torque Transmitting Chain Member 9. FIGS. 52 and 53 show sectional-views of a sections of Leveling Loop 16 as cut per FIG. 51.

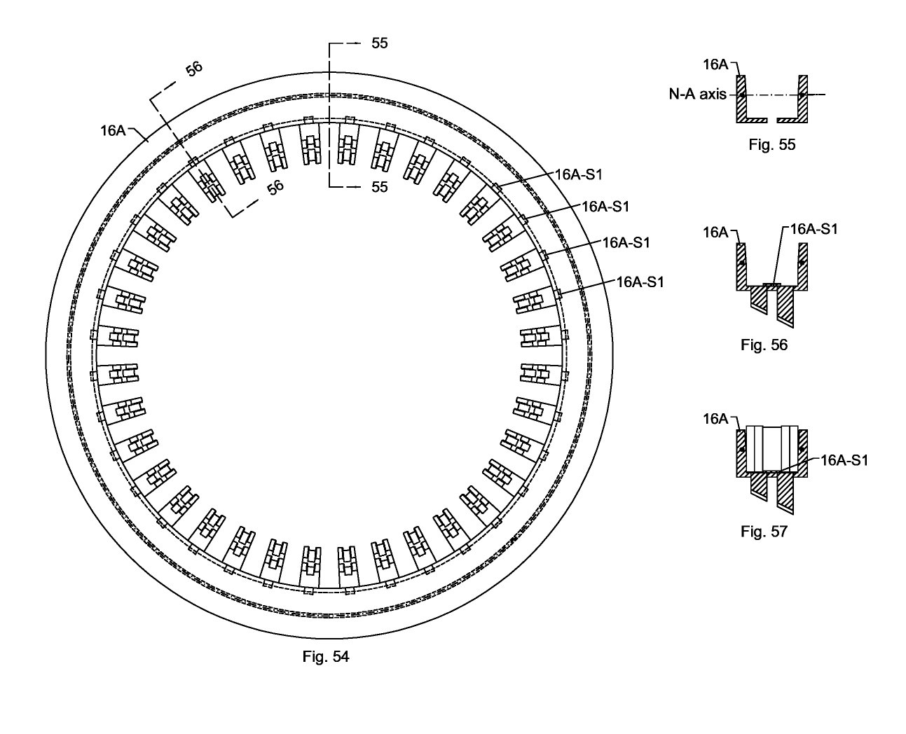

FIGS. 54 to 56 show a Leveling Loop 16A. Leveling Loop 16A is basically identical to Leveling Loop 16, as such it also has a cross-section that it is channel-shaped with two sides and a horizontal base (see FIG. 55); but unlike Leveling Loop 16, for Leveling Loop 16A each surface of said base on which a roller of a chain rests has a Resting Base 16A-S1 (see FIGS. 54 and 56). Each Resting Base 16A-S1 has a “partial roller cut-out” for a roller of the chain with which it is used; the purpose of this is to reduce the contact stresses that occur when a chain rests on a leveling loop.

FIG. 57 shows the cross-section of Leveling Loop 16A on which a Chain Section (which is not labeled and not hatched) rests, here the roller of said Chain Section is resting on Resting Base 16A-S1 in a manner so that the Link Plates of said Chain Section are not resting on said Leveling Loop 16A.

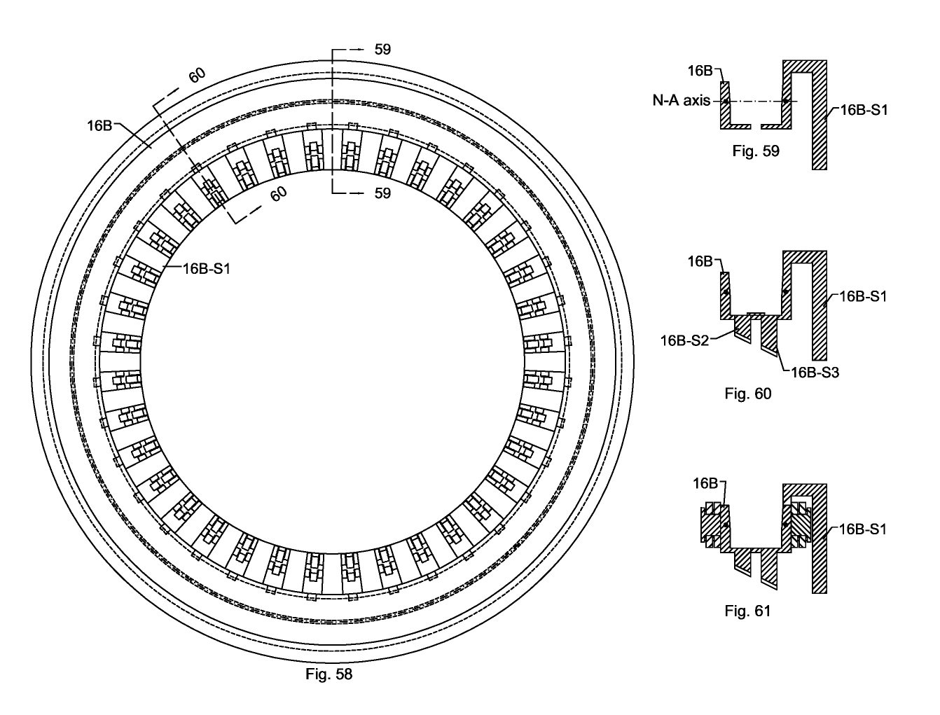

FIGS. 58 to 61 show a Leveling Loop 16B. Leveling Loop 16B is basically identical to Leveling Loop 16A, except that it has a Rim Extension 16B-S1 on the “smaller cone diameter resting side” of its leveling loop. A cross-section showing Rim Extension 16B-S1 are shown in FIGS. 59 to 61, and a side-view of Rim Extension 16B-S1 is shown in FIG. 58. Rim Extension 16B-S1 is attached to the top-end of the “smaller cone diameter resting side” of its leveling loop, it extends sideway in order to avoid interference with its Chain Members (see FIG. 61), and then extends downwards in order to form an unbroken rim that extends below the lowest surface of its resting legs, which are Leg 16B-S2 and Leg 16B-S3. The purpose of Rim Extension 16B-S1 is to prevent the legs from opposite sections of a leveling loop from becoming engaged.

For simplicity and the sake of introducing a concept, the items of this section (Torque Transmitting Chain Members, Non-Torque Transmitting Chain Members, and Leveling Loops) are all shown for a single-stranded chain only; but obviously with some slight modification (such as using two teeth instead of one tooth on a link for example), the items of this section can also be used with multi-stranded chains.

### Torque Transmitting Member and Non-Torque Transmitting Member For a Uniformed Surfaced Cone

In this section, a Torque Transmitting Member and Non-Torque Transmitting Member for a Uniformed Surfaced Cone is described. The items of this section can be used with a transmission belt that is a Timing Belt.

The Torque Transmitting Member and Non-Torque Transmitting Member of this section each comprises of a elastomer segment that has reinforcement plates.

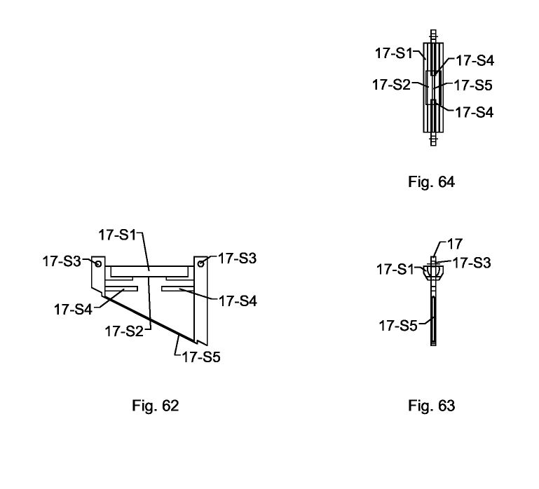

A reinforcement plate for the Torque Transmitting Member of this section, which is labeled as Reinforcement Plate 17, is shown in FIGS. 62 to 64. Reinforcement Plate 17 is shaped like a flat plate (with cut-outs) that as Tooth 17-S1 shaped on it. Tooth 17-S1 is shaped similar to a channel with a U-cross-section (see FIG. 63). For the center section of Tooth 17-S1, which is labeled as Center Section 17-S2, the bottom surface of the U-shaped cross-section is removed (see FIGS. 62 and 64).

Reinforcement Plate 17 also has two holes 17-S3; these holes are for the reinforcement wires of its Torque Transmitting Member; these holes should be located so that the neutral-axis of its Torque Transmitting Member coincides with the neutral-axis of its transmission belt.

Reinforcement Plate 17 also has two Male Rail Reinforcements 17-S4. Male Rail Reinforcements 17-S4 are used to hold-in-place and guide the Leveling Extension of its Non-Torque Transmitting Member (which will be described below).

And Reinforcement Plate 17 also has a Notch 17-S5. Notch 17-S5 is used to prevent the Leveling Extension of its Non-Torque Transmitting Member from slipping-out of its Torque Transmitting Member due to centrifugal forces.

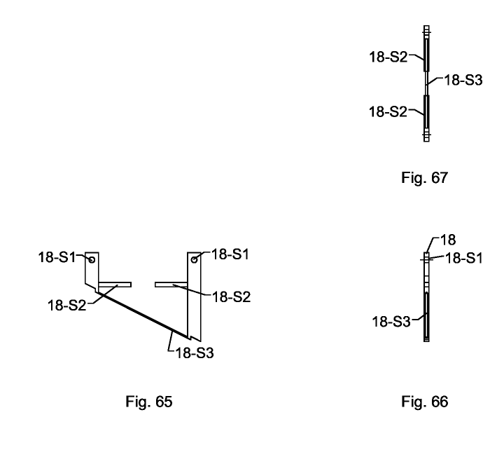

A reinforcement plate for the Non-Torque Transmitting Member of this section, which is labeled as Reinforcement Plate 18, is shown in FIGS. 65 to 67. Reinforcement Plate 18 is basically identical to Reinforcement Plate 17, except that it doesn't have a Tooth 17-S1, and as such also doesn't have a Center Section 17-S2. As such Reinforcement Plate 18 also has: two holes that are used for the reinforcement wires of its Non-Torque Transmitting Member, which here are labeled as holes 18-S1; two Male Rail Reinforcements, which here are labeled as Male Rail Reinforcements 18-S2 and here are used to hold-in-place and guide the Leveling Extension of its Torque Transmitting Member (which will be described below); and a Notch, which here is labeled as Notch 18-S3 and here is used to prevent the Leveling Extension of its Torque Transmitting Member from slipping-out of its Non-Torque Transmitting Member due to centrifugal forces. Also, the Holes 18-S1 of Reinforcement Plate 18 should be located so that the neutral-axis of its Non-Torque Transmitting Member coincides with the neutral -axis of its transmission belt.

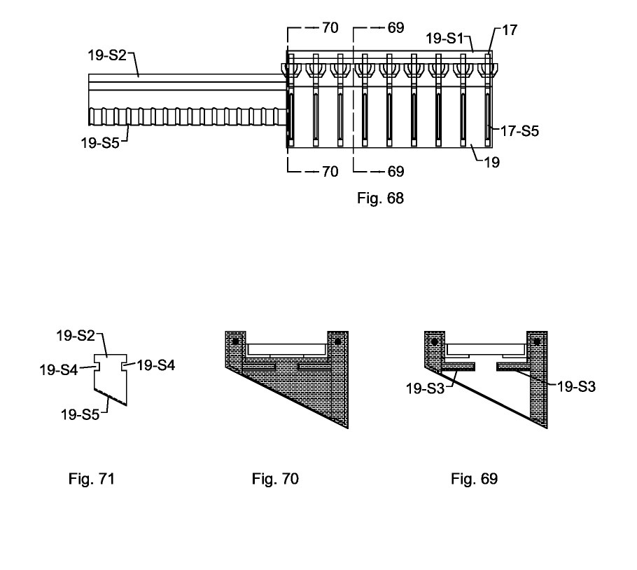

A Torque Transmitting Member of this section, which is labeled as Torque Transmitting Member 19, is shown in FIGS. 68 to 71. It comprises of a Torque Transmitting Member Section 19-S1 and a Leveling Extension 19-S2. In its assembled state, Leveling Extension 19-S2 is inserted into its Non-Torque Transmitting Member from which it will telescope in-and-out as the transmission diameter of its cone is changed.

A cross-section of Torque Transmitting Member Section 19-S1 is shown in FIG. 69. The elastomer portion of said cross-section are shown in hatching. Said cross-section has two Male Rails 19-S3, which are shown in hatching, and as such are in-cased in elastomer. The elastomer of Male Rails 19-S3 should be soft enough to allow the grooves of the Leveling Extension of its Non-Torque Transmitting Member to enter and exit the Notches 17-S5 of Torque Transmitting Member Section 19-S1, as the transmission diameter of its cone is changed. But the elastomer of Male Rails 19-S3 should be stiff enough to prevent the Leveling Extension of its Non-Torque Transmitting Member from exiting Torque Transmitting Member Section 19-S1 due to centrifugal forces.

The rear-end of Torque Transmitting Member Section 19-S1, which is shown in FIG. 70, has a different cross-section than the rest of Torque Transmitting Member Section 19-S1, this is because Leveling Extension 19-S2 needs to be attached to it. The elastomer portion of this cross-section is also shown in hatching. If instead of Leveling Extensions, a Leveling Loop that can expand and contract is used, then this cross-section as well as Leveling Extension 19-S2 are not needed.

A rear-view of Leveling Extension 19-S2 is shown in FIG. 71. In its assembled state, Leveling Extension 19-S2 will be inserted into Non-Torque Transmitting Member Section 20-S1 (described below). Leveling Extension 19-S2 has Female Rails 19-S4 into which the Male Rails of it Non-Torque Transmitting Member (which are labeled as Male Rails 20-S3 in FIG. 73) are inserted.

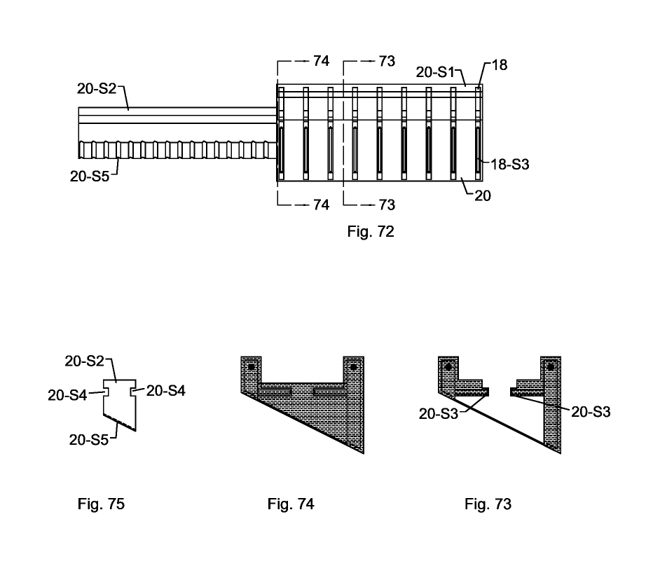

Leveling Extension 19-S2 also has Grooves 19-S5; Grooves 19-S5 with Notches 18-S3 of the reinforcement plates of its Non-Torque Transmitting Member Section 20-S1 (see FIG. 72) are used to prevent Leveling Extension 19-S2 from getting pulled-out of Non-Torque Transmitting Member Section 20-S1 due to centrifugal forces. Grooves 19-S5 should have “half the pitch” of the pitch of the teeth of its transmission belt, since Leveling Extension 19-S2 moves in-or-out “half a tooth” distance from Non-Torque Transmitting Member Section 20-S1 for a “one tooth distance” transmission circumference change. It is also recommended that Grooves 19-S5 are shaped so that they provide more resistance to Leveling Extension 19-S2 being pulled-out than pushed-in. Also, the pitch of the teeth of the transmission belt used with Torque Transmitting Member 19 should be identical to the pitch of the teeth of Torque Transmitting Member 19.

A Non-Torque Transmitting Member of this section, which is labeled as Non-Torque Transmitting Member 20, is shown in FIGS. 72 to 75. It comprises of a Non-Torque Transmitting Member Section 20-S1 and a Leveling Extension 20-S2. In its assembled state, Leveling Extension 20-S2 is inserted into its Torque Transmitting Member from which it will telescope in-and-out as the transmission diameter of its cone is changed.

A cross-section of Torque Transmitting Member Section 19-S1 is shown in FIG. 69. The elastomer portions of said cross-section are shown in hatching. Said cross-section has two Male Rails 19-S3, which are shown in hatching, and as such are in-cased in elastomer. The elastomer of Male Rails 19-S3 should be soft enough to allow the grooves of the Leveling Extension of its Non-Torque Transmitting Member to enter and exit the Notches 17-S5 of Torque Transmitting Member Section 19-S1, as the transmission diameter of its cone is changed. But the elastomer of Male Rails 19-S3 should be stiff enough to prevent the Leveling Extension of its Non-Torque Transmitting Member from exiting Torque Transmitting Member Section 19-S1 due to centrifugal forces.

A cross-section of Non-Torque Transmitting Member Section 20-S1 is shown in FIG. 73. The elastomer portion of said cross-section are shown in hatching. Said cross-section has two Male Rails 20-S3, which are shown in hatching, and as such are in-cased in elastomer. The elastomer of Male Rails 20-S3 should be soft enough to allow the grooves of the Leveling Extension of its Torque Transmitting Member to enter and exit the Notches 18-S3 of Non-Torque Transmitting Member Section 20-S1, as the transmission diameter of its cone is changed. But the elastomer of Male Rails 20-S3 should be stiff enough to prevent the Leveling Extension of its Torque Transmitting Member from exiting Non-Torque Transmitting Member Section 20-S1 due to centrifugal forces.

The rear-end of Non-Torque Transmitting Member Section 20-S1, which is shown in FIG. 74, has a different cross-section than the rest of Non-Torque Transmitting Member Section 20-S1, this is because Leveling Extension 20-S2 needs to be attached to it. The portion of this cross-section are also shown in hatching. If instead of Leveling Extensions, a Leveling Loop that can expand and contract is used, then this cross-section as well as Leveling Extension 20-S2 are not needed.

A rear-view of Leveling Extension 20-S2 is shown in FIG. 75. In its assembled state, Leveling Extension 20-S2 will be inserted into Torque Transmitting Member Section 19-S1. Leveling Extension 20-S2 has Female Rails 20-S4 into which the Male Rails of it Torque Transmitting Member (which are labeled as Male Rails 19-S3 in FIG. 69) are inserted.

Leveling Extension 20-S2 also has Grooves 20-S5; Grooves 20-S5 with Notches 17-S5 of the reinforcement plates of its Torque Transmitting Member Section 19-S1 (see FIG. 68) are used to prevent Leveling Extension 20-S2 from getting pulled-out of Torque Transmitting Member Section 19-S1 due to centrifugal forces. Grooves 20-S5 should have “half the pitch” of the pitch of the teeth of its transmission belt, since Leveling Extension 20-S2 moves in-or-out “half a tooth” distance from Torque Transmitting Member Section 19-S1 for a “one tooth distance” transmission circumference change. It is also recommended that Grooves 20-S5 are shaped so that they provide more resistance to Leveling Extension 20-S2 being pulled-out than pushed-in.

In order to attach Torque Transmitting Member 19 and Non-Torque Transmitting Member 20 to a “cone with one torque transmitting member” that is referred to as a front pin belt cone assembly 520A in U.S. Pat. No. 8,628,439 (refer to column 90 line 64 to column 99 line 11; and FIGS. 91A, 91B, 92A, 92B, 93 to 101 of U.S. Pat. No. 8,628,439); two Leading End Torque Transmitting Member Sleeves and a Trailing End Torque Transmitting Member Sleeve can be used, in the same way two Leading End Torque Transmitting Member Sleeves and a Trailing End Torque Transmitting Member Sleeve are used to attach pin belt torque transmitting member 590 (see FIG. 95 of U.S. Pat. No. 8,628,439) of U.S. Pat. No. 8,628,439 to its cone.

### Alternate Torque Transmitting Member and Non-Torque Transmitting Member For a Uniformed Surfaced Cone

In this section, an alternate Torque Transmitting Member and an alternate Non-Torque Transmitting Member for a Uniformed Surfaced Cone is described. The items of this section can be used with a Transmission Belt described in this section.

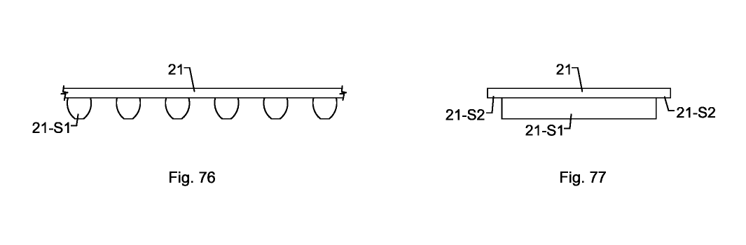

The Transmission Belt to be used with the items of this section is shown in FIGS. 76 and 77, where it is labeled as Transmission Belt 21. Transmission Belt 21 has Teeth 21-S1, which are used for torque transmission. And Transmission Belt 21 also has Flanges 21-S2, which are used to support Transmission Belt 21 where necessary. Unlike a Transmission Pulley, a Cone Assembly of this section provides less resting surfaces for its Transmission Belt; in order to compensate for this, additional strengthening reinforcements (such as shear strength reinforcements, etc.) can be added to Transmission Belt 21.

The Torque Transmitting Member of this section comprises of a elastomer segment that has reinforcement plates and reinforcement wires.

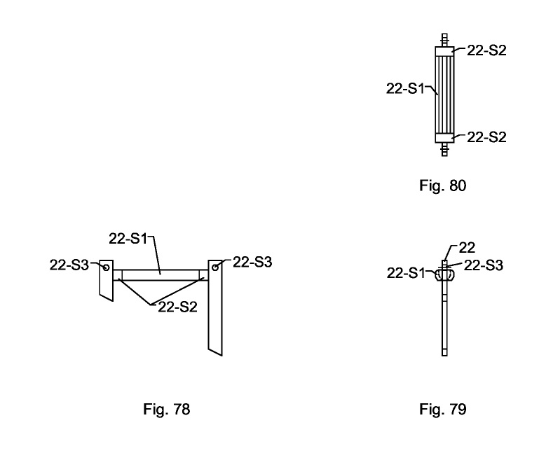

A reinforcement plate for the Torque Transmitting Member of this section, which is labeled as Reinforcement Plate 22, is shown in FIGS. 78 to 80. Reinforcement Plate 22 is shaped like a flat plate (for which its middle-section has been cut-out) that as Tooth 22-S1 shaped on it. Tooth 22-S1 is shaped similar to a channel with a U-cross-section for which its bottom surface has been removed (see FIG. 79).

Since the middle-section of the flat plate of Reinforcement Plate 22 has been cut-out, the flat plate of Reinforcement Plate 22 has two vertical sides (see FIG. 78). Tooth 22-S1 is connected to these sides through solid Tooth Ends 22-S2 (see FIGS. 78 to 80). Tooth Ends 22-S2 are basically end-walls that connect Tooth 22-S1 to said sides.

Reinforcement Plate 22 also has two Holes 22-S3; these holes are for the reinforcement wires of its Torque Transmitting Member; these holes should be located so that the bending-axis of its Torque Transmitting Member coincides with the bending-axis of its transmission belt.

In order to attach a Torque Transmitting Member of this section to a “cone with one torque transmitting member” that is referred to as a front pin belt cone assembly 520A in U.S. Pat. No. 8,628,439 (refer to column 90 line 64 to column 99 line 11; and FIGS. 91A, 91B, 92A, 92B, 93 to 101 of U.S. Pat. No. 8,628,439), a Leading End Reinforcement Plate 22A, a Trailing Sleeve Reinforcement Plate 22B, and a Trailing End Reinforcement Plate 22C can be used.

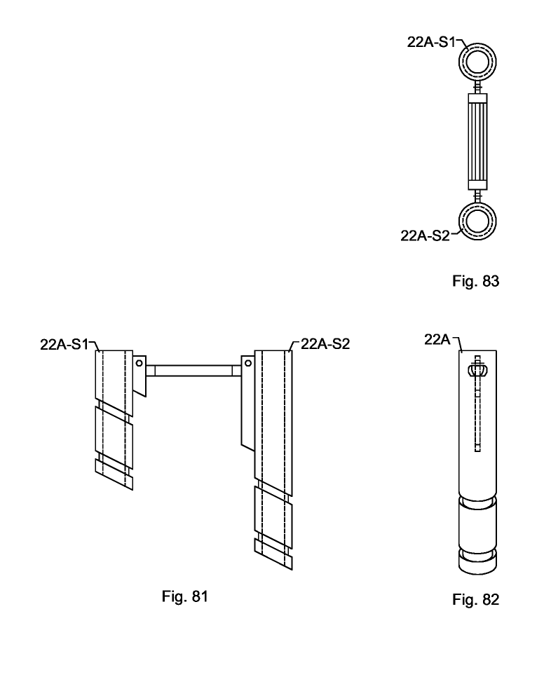

FIGS. 81 to 83 show a Leading End Reinforcement Plate 22A. Leading End Reinforcement Plate 22A is identical to Reinforcement Plate 22, except that Attachment Sleeves are attached to its sides; these Attachment Sleeves are labeled as Attachment Sleeves 22A-S1 and 22A-S2.

Attachment Sleeves 22A-S1 and 22A-S2 are used to attach the Leading End of a Torque Transmitting Member to a torque transmitting member carriage 550A of a front pin belt cone assembly 520A of U.S. Pat. No. 8,628,439; using the same method the sleeves of the leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

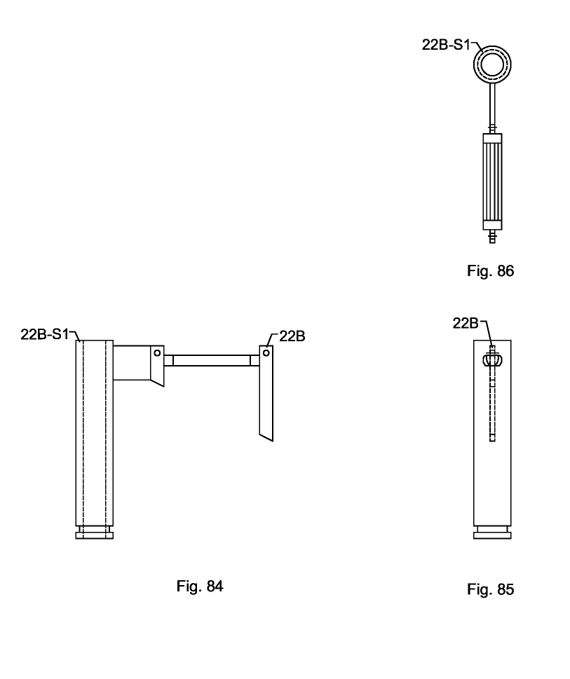

FIGS. 84 to 86 show a Trailing Sleeve Reinforcement Plate 22B. Trailing Sleeve Reinforcement Plate 22B is identical to Reinforcement Plate 22, except that the larger cone dimeter resting side of Trailing Sleeve Reinforcement Plate 22B has an Attachment Sleeve, which is labeled as Attachment Sleeve 22B-S1, attached to it. The bottom end of Attachment Sleeve 22B-S1 has a Locking Ring Groove 22B-S2, which is used to secure Attachment Sleeve 22B-S1 to its cone by sliding a fastener such as a Dome Shaped Nut or a Ball Clamp (which is preferred) into Attachment Sleeve 22B-S1, and securing the fastener by inserting a Locking Ring into Locking Ring Groove 22B-S2.

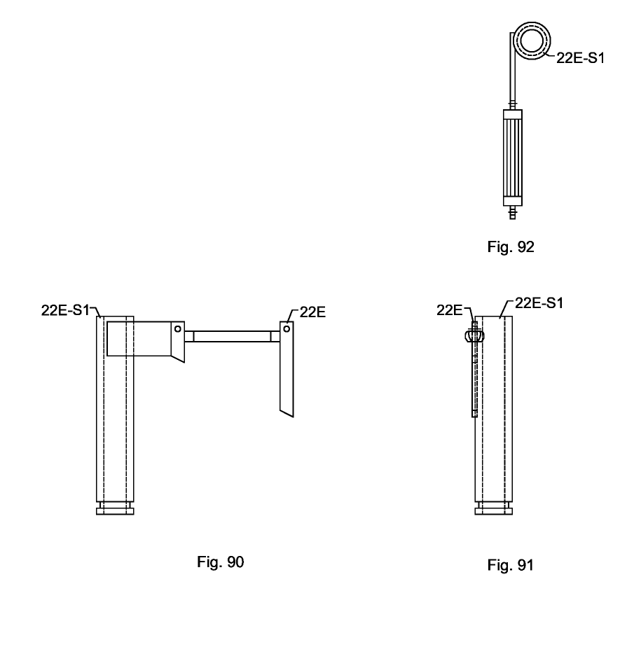

Attachment Sleeve 22B-S1 is used to connect its Torque Transmitting Member to its Trailing End Slide; using the same method used in U.S. Pat. No. 8,628,439 to connect the trailing end of a pin belt torque transmitting member 590 to its trailing end slide 565-S1 (see FIGS. 91A, 91B, 92A, 92B, 93 to 99). If necessary for alignment with Locking Ring Pin 22C-S3 in their Trailing End Cut (see paragraphs below for details), Attachment Sleeve 22B-S1 can be positioned behind or in-front of its Reinforcement Plate. FIGS. 87 to 89 show a Trailing Sleeve Reinforcement Plate 22D for which its Attachment Sleeve 22D-S1 is positioned behind its Reinforcement Plate; and FIGS. 90 to 92 show a Trailing Sleeve Reinforcement Plate 22E for which its Attachment Sleeve 22E-S1 is positioned in-front of its Reinforcement Plate.

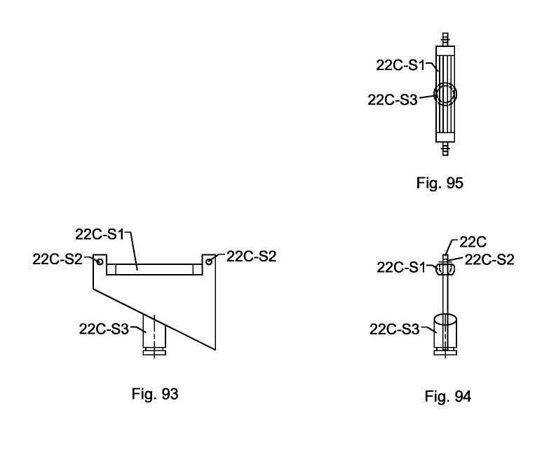

FIGS. 93 to 95 show a Trailing End Reinforcement Plate 22C. Trailing End Reinforcement Plate 22C is shaped like a flat plate that as Tooth 22C-S1 shaped on it. Tooth 22C-S1 is shaped similar to a channel with a U-cross-section (see FIG. 94). Here the bottom surface of the U-cross-section is formed by the upper surface of the middle-section of the flat plate (see FIGS. 93 and 94).

Trailing End Reinforcement Plate 22C also has two holes 22C-S3; these holes are for the reinforcement wires of its Torque Transmitting Member; these holes should be located so that the bending-axis of its Torque Transmitting Member coincides with the bending-axis of its transmission belt.

In addition, Trailing End Reinforcement Plate 22C also has a Locking Ring Pin 22C-S3. Locking Ring Pin 22C-S3 is used to secure the Trailing End of its Torque Transmitting Member to its cone by sliding a fastener such as a Dome Shaped Nut or a Ball Clamp (which is preferred) into Locking Ring Pin 22C-S3, and securing the fastener by inserting a Locking Ring into Locking Ring Groove 22C-S4 of Locking Ring Pin 22C-S3.

The Torque Transmitting Member using the Trailing Sleeve Reinforcement Plate (such as Trailing Sleeve Reinforcement Plate 22B, 22D or 22E) and Trailing End Reinforcement Plate 22C should be designed so that its Locking Ring Pin 22C-S3 and its “Attachment Sleeve of its Trailing Sleeve Reinforcement Plate” (such as Attachment Sleeve 22B-S1, 22D-S1 or 22E-S1) can slide in the same Trailing End Cut (the Trailing End Cuts for a cone are shown and labeled as trailing end cuts 540-S6 in FIG. 112B of U.S. Pat. No. 8,628,439), in a manner so that Locking Ring Pin 22C-S3 can engage with its Trailing End Cut surface that prevents its Torque Transmitting Member from moving towards its Leading End Cut, so that Locking Ring Pin 22C-S3 can transfer torque in the direction that pulls from the Trailing End towards the Leading End of its cone; and preferably (but not necessarily) also prevents its Torque Transmitting Member from moving away from its Leading End. If necessary, some play between the “Attachment Sleeve of the Trailing Sleeve Reinforcement Plate” and its Trailing End Cut is allowed. And if there are interferences between the fastener of Locking Ring Pin 22C-S3 and the fastener of the “Attachment Sleeve of the Trailing Sleeve Reinforcement Plate”, then it is not necessary to use the fastener for the “Attachment Sleeve of the Trailing Sleeve Reinforcement Plate”.

Although this is not preferred, but if it is too impractical to place Attachment Sleeve 22B-S1, 22D-S1 or 22E-S1 and Locking Ring Pin 22C-S3 in the same Trailing End Cut; then Locking Ring Pin 22C-S3 and its Trailing End Reinforcement Plate 22C do not have to be used. For this configuration, Attachment Sleeve 22B-S1, 22D-S1 or 22E-S1 should be secured to its cone using a fastener.

The Leading End Cuts for a cone are shown and labeled as leading end cuts 540-S1 in FIG. 112B of U.S. Pat. No. 8,628,439. For a said cone that uses a Torque Transmitting Member of this section, the Leading End Cuts are used to insert the Attachment Sleeves of a Leading End Reinforcement Plate.

The proper location of the “Attachment Sleeve of the Trailing Sleeve Reinforcement Plate” relative to Locking Ring Pin 22C-S3 as well as the shape and size of all cuts on a cone can be determined through trial-and-error and experimentation (such as tracing for example).

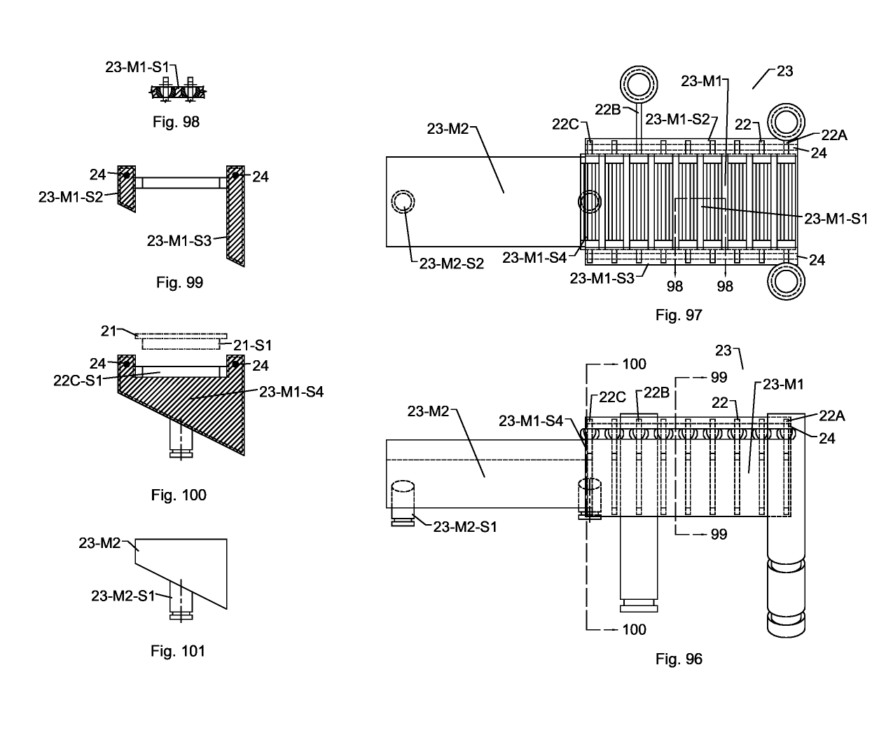

A Torque Transmitting Member of this section, which is labeled as Torque Transmitting Member 23, is shown in FIGS. 96 to 101. It comprises of a Torque Transmitting Member Section 23-M1 and a Leveling Extension 23-M2. In its assembled state, Leveling Extension 23-M2 is inserted into its Non-Torque Transmitting Member from which it will telescope in-and-out as the transmission diameter of its cone is changed. The purpose of Leveling Extension 23-M2 is to provide a base of for Teeth 21-S1 of Transmission Belt 21.

Torque Transmitting Member Section 23-M1 comprises of a Leading End Reinforcement Plate 22A, a Trailing Sleeve Reinforcement Plate 22B, a Trailing End Reinforcement Plate 22C, and several Reinforcement Plates 22 that are joined together by two Reinforcement Wires 24 and encased by elastomer members as shown in FIGS. 96 to 101 and as described below.

Between all teeth of the reinforcement plates, an elastomer Belt Resting Section 23-M1-S1 exist (see FIGS. 97 and 98). Belt Resting Section 23-M1-S1 is used to provide a resting place for Transmission Belt 21 and its Flanges 21-S2 on Torque Transmitting Member 23.

It is recommended that Transmission Belt 21 has Teeth 21-S1 that can wedge into the teeth their Torque Transmitting Member Section 23-M1. Through this wedging action the teeth of Torque Transmitting Member Section 23-M1 will also support Transmission Belt 21; so that if desired, Belt Resting Section 23-M1-S1 can be omitted.

If Belt Resting Sections 23-M1-S1 prevent Teeth 21-S1 from properly wedging into the teeth of Torque Transmitting Member Section 23-M1, then Belt Resting Sections 23-M1-S1 should be redesigned or omitted. And if the Tooth Ends (such as Tooth Ends 22-S2 of Reinforcement Plate 22) of Torque Transmitting Member Section 23-M1 prevent Teeth 21-S1 from properly wedging into the teeth of Torque Transmitting Member Section 23-M1, then Tooth Ends 22-S2 should be redesigned, such as by removing the interfering surfaces for example.

A partial cross-section of Torque Transmitting Member Section 23-M1 as cut per FIG. 96 is shown in FIG. 99; the only item not shown in FIG. 99 is Belt Resting Section 23-M1-S1, since Belt Resting Sections 23-M1-S1 are not part of a continues elastomer member that joins the reinforcement plates of Torque Transmitting Member Section 23-M1 along its length (from front to rear). The elastomer portions of said cross-section (which are sections of elastomer members) and the Reinforcement Wires 24 are shown in hatching; these left side (labeled as Left Elastomer Member 23-M1-S2) and right side (labeled as Right Elastomer Member 23-M1-S3) elastomer members join the reinforcement plates of Torque Transmitting Member Section 23-S1 along its length.

Left Elastomer Member 23-M1-S2 and Right Elastomer Member 23-M1-S3, which are shown in hatching in FIG. 99, run through the entire length of Torque Transmitting Member Section 23-M1, except for the rear-end (see FIG. 97).

The rear-end of Torque Transmitting Member Section 23-M1, which is shown as a sectional-view in FIG. 100, has a different cross-section than the rest of Torque Transmitting Member Section 23-M1, this is because Leveling Extension 23-M2 needs to be attached to it. The elastomer portion of this cross-section (which is labeled as Rear Elastomer Member 23-M1-S4) and the Reinforcement Wires 24 are shown in hatching. Rear Elastomer Member 23-M1-S4 is also shown in FIGS. 96 and 97. If instead of Leveling Extensions, a Leveling Loop that can expand and contract is used, then this cross-section as well as Leveling Extension 23-M2 are not needed.

FIG. 100 also shows a Transmission Belt 21 which is currently not engaged with its Torque Transmitting Member Section 23-M1. When engaged, the Teeth 21-S1 of Transmission Belt 21 are inside of the Teeth of Torque Transmitting Member Section 23-M1 (FIG. 100 shows a tooth of Torque Transmitting Member Section 23-M1, which is labeled as Tooth 22C-S1).

A rear-view of Leveling Extension 23-M2 is shown in FIG. 101. In its assembled state, Leveling Extension 23-M2 will be inserted into a Non-Torque Transmitting Member Section 26-M1 (described in the paragraphs below). Leveling Extension 23-M2 also has a Locking Ring Pin 23-M2-S1. Locking Ring Pin 23-M2-S1 is used to secure the rear-end of Leveling Extension 23-M2 to its cone using fasteners such as a Dome Shaped Nut or Ball Clamp (which is preferred) for example. The shape and size of the cut for Locking Ring Pin 23-M2-S1 on its cone can be determined through trial-and-error and experimentation (such as tracing for example).

The Non-Torque Transmitting Member of this section has two separate elastomer side members that are joined at the leading end and trailing end (see FIG. 116 for a top-view and FIG. 118 for a sectional-view). One elastomer side member has Reinforcement Plates 25-M1 and a Trailing Sleeve Reinforcement Plate 25B (see FIG. 116); and the other elastomer side member has Reinforcement Plates 25-M2 (see FIG. 116). The two sides are then joined at the leading end and trailing end using Leading End Reinforcement Plate 25A and Trailing End Reinforcement Plate 25C (see FIG. 116).

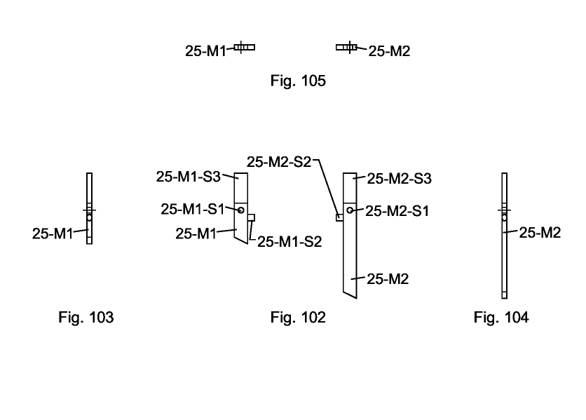

A Reinforcement Plate 25-M1 and a Reinforcement Plate 25-M2 are shown in FIGS. 102 to 105. Reinforcement Plate 25-M1 has a Hole 25-M1-S1, and Reinforcement Plate 25-M2 has a Hole 25-M2-S1; these holes are for the reinforcement wires of its Non-Torque Transmitting Member; these holes should be located so that the bending-axis of its Non-Torque Transmitting Member coincides with the bending-axis of its transmission belt.

Reinforcement Plate 25-M1 also has a Rail Reinforcement 25-M1-S2, and Reinforcement Plate 25-M2 also has a Rail Reinforcement 25-M2-S2. Rail Reinforcements 25-M1-S2 and 25-M2-S2 are used as reinforcements for rails that are used to hold-in-place and guide Leveling Extension 23-M2 of its Torque Transmitting Member and used to provide a resting place for Flanges 21-S2 of Transmission Belt 21 (see FIG. 121).

In addition, in order to prevent excessive vibration due to centrifugal forces, it is recommended that each “Reinforcement Plate Pair” or “Reinforcement Plate” of a Non-Torque Transmitting Member has the same weight as the corresponding (oppositely positioned) Reinforcement Plate of its Torque Transmitting Member; so that the centrifugal forces of the Torque Transmitting and Non-Torque Transmitting Members cancel each other out. For this purpose Reinforcement Plate 25-M1 also has a Balancing Weight 25-M1-S3, and Reinforcement Plate 25-M2 also has a Balancing Weight 25-M2-S3. These Balancing Weights are not necessary if other means for balancing the weight of the Reinforcement Plates are used; such as through the selection of material, adjusting the thickness of the plates, etc.

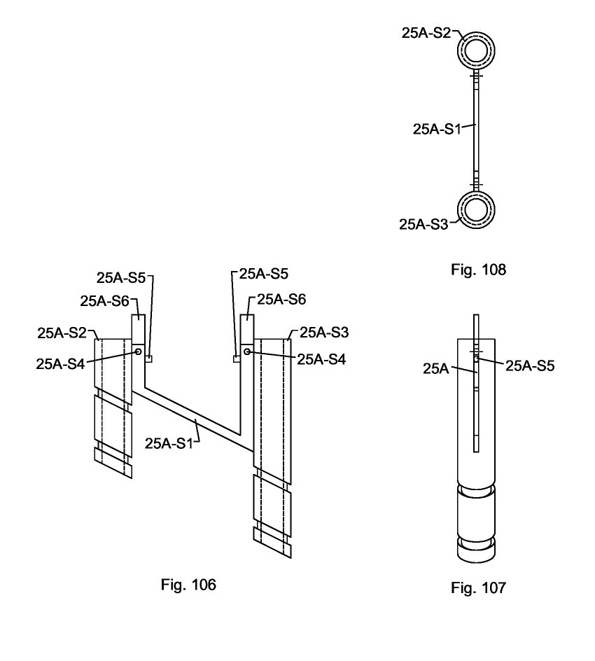

Leading End Reinforcement Plate 25A is shown in FIGS. 106 to 108. It has two vertical sides and an angled Base 25A-S1. When attached to its cone, Base 25A-S1 is positioned beneath the surface of its cone so that it is not in the way of the Leveling Extension that is inserted into its Non-Torque Transmitting Member, which is resting on the surface of its cone.

In addition, Attachment Sleeves are attached to the sides of Leading End Reinforcement Plate 25A; these Attachment Sleeves are labeled as Attachment Sleeves 25A-S2 and 25A-S3.

Attachment Sleeves 25A-S2 and 25A-S3 are used to attach the Leading End of a Non-Torque Transmitting Member to a torque transmitting member carriage 550A of a front pin belt cone assembly 520A of U.S. Pat. No. 8,628,439; using the same method the sleeves of the leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

Leading End Reinforcement Plate 25A also has two Holes 25A-S4; these holes are for the reinforcement wires of its Non-Torque Transmitting Member; these holes should be located so that the bending-axis of its Non-Torque Transmitting Member coincides with the bending-axis of its transmission belt.

Leading End Reinforcement Plate 25A also has two Rail Reinforcements 25A-S5. Rail Reinforcements 25A-S5 are used as reinforcements for rails that are used to hold-in-place and guide Leveling Extension 23-M2 of its Torque Transmitting Member and used to provide a resting place for Flanges 21-S2 of Transmission Belt 21.

In addition, in order to prevent excessive vibration due to centrifugal forces, it is recommended that each “Reinforcement Plate Pair” or “Reinforcement Plate” of a Non-Torque Transmitting Member has the same weight as the corresponding (oppositely positioned) Reinforcement Plate of its Torque Transmitting Member; so that the centrifugal forces of the Torque Transmitting and Non-Torque Transmitting Members cancel each other out. For this purpose Leading End Reinforcement Plate 25A also has a Balancing Weights 25A-S6. These Balancing Weights are not necessary if other means for balancing the weight of the Reinforcement Plates are used; such as through the selection of material, adjusting the thickness of the plates, etc.

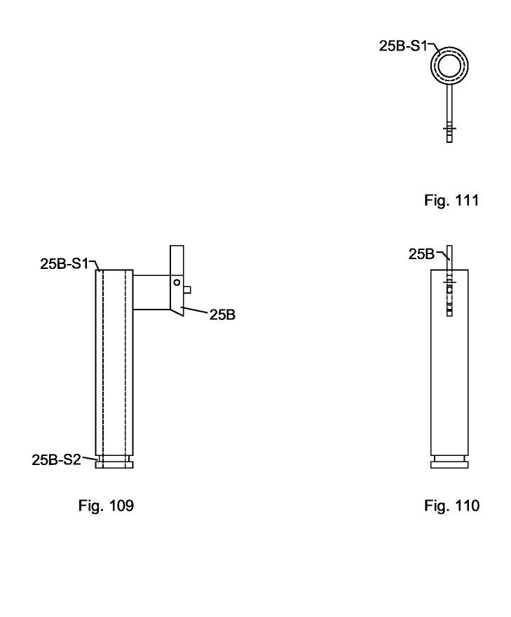

FIGS. 109 to 111 show a Trailing Sleeve Reinforcement Plate 25B. Trailing Sleeve Reinforcement Plate 25B is identical to Reinforcement Plate 25-M1, except that it has an Attachment Sleeve, which is labeled as Attachment Sleeve 25B-S1, attached to it. The bottom end of Attachment Sleeve 25B-S1 has a Locking Ring Groove 25B-S2, which is used to secure Attachment Sleeve 25B-S1 to its cone by sliding a fastener such as a Dome Shaped Nut or a Ball Clamp (which is preferred) into Attachment Sleeve 25B-S1, and securing the fastener by inserting a Locking Ring into Locking Ring Groove 25B-S2.

Attachment Sleeve 25B-S1 is used to connect its Non-Torque Transmitting Member to its Trailing End Slide; using the same method used in U.S. Pat. No. 8,628,439 to connect the trailing end of a pin belt torque transmitting member 590 to its trailing end slide 565-S1 (see FIGS. 91A, 91B, 92A, 92B, 93 to 99). If necessary for alignment with Locking Ring Pin 25C-S3 in their Trailing End Cut (see paragraphs below for details), Attachment Sleeve 25B-S1 can be positioned behind or in-front of its Reinforcement Plate; in the same manner as Attachment Sleeve 22B-S1 can be positioned behind or in-front of its Reinforcement Plate (see FIGS. 87 to 92).

FIGS. 112 to 114 show a Trailing End Reinforcement Plate 25C. Trailing End Reinforcement Plate 25C is shaped like a flat plate that as a Cut-out 25C-S1 shaped on it. When its Non-Torque Transmitting Member is encased in elastomer (such as rubber, polyurethane, Viton, etc.), the base of the elastomer that is covering Cut-out 25C-S1 will provide a level resting base for Teeth 21-S1 of Transmission Belt 21, and the sides of the elastomer that is covering Cut-out 25C-S1 are used to maintain the lateral alignment of Transmission Belt 21 within Trailing End Reinforcement Plate 25C (see FIG. 122).

Trailing End Reinforcement Plate 25C also has two holes 25C-S2; these holes are for the reinforcement wires of its Non-Torque Transmitting Member; these holes should be located so that the bending-axis of its Non-Torque Transmitting Member coincides with the bending-axis of its transmission belt (which here is Transmission Belt 21).

In addition, Trailing End Reinforcement Plate 25C also has a Locking Ring Pin 25C-S3. Locking Ring Pin 25C-S3 is used to secure the Trailing End of its Non-Torque Transmitting Member to its cone by sliding a fastener such as a Dome Shaped Nut or a Ball Clamp (which is preferred) into Locking Ring Pin 25C-S3, and securing the fastener by inserting a Locking Ring into Locking Ring Groove 25C-S5 of Locking Ring Pin 25C-S3.

In order to prevent excessive vibration due to centrifugal forces, it is recommended that each “Reinforcement Plate Pair” or “Reinforcement Plate” of a Non-Torque Transmitting Member has the same weight as the corresponding (oppositely positioned) Reinforcement Plate of its Torque Transmitting Member; so that the centrifugal forces of the Torque Transmitting and Non-Torque Transmitting Members cancel each other out. For this purpose Trailing End Reinforcement Plate 25C also has a Balancing Weights 25C-S4. These Balancing Weights are not necessary if other means for balancing the weight of the Reinforcement Plates are used; such as through the selection of material, adjusting the thickness of the plates, etc.

Preferably, the Non-Torque Transmitting Member using Trailing Sleeve Reinforcement Plate 25B and Trailing End Reinforcement Plate 25C is designed so that its Locking Ring Pin 25C-S3 and its Attachment Sleeve 25B-S1 can slide in the same Trailing End Cut, in a manner so that Locking Ring Pin 25C-S3 can engage with its Trailing End Cut surface that prevents its Non-Torque Transmitting Member from moving towards its Leading End Cut, so that Locking Ring Pin 25C-S3 can transfer torque in the direction that pulls from the Trailing End towards the Leading End of its cone; and to a lesser preferable extent, also so as to prevents its Non-Torque Transmitting Member from moving away from its Leading End. If necessary, some play between Attachment Sleeve 25B-S1 and its Trailing End Cut is allowed. And if there are interferences between the fastener of Locking Ring Pin 25C-S3 and the fastener of Attachment Sleeve 25B-S1, then it is not necessary to use the fastener of Attachment Sleeve 25B-S1.

Although this is not preferred, but if it is too impractical to place Attachment Sleeve 25B-S1 and Locking Ring Pin 25C-S3 in the same Trailing End Cut; then Locking Ring Pin 25C-S3 and its Trailing End Reinforcement Plate 25C do not have to be used. For this configuration, Attachment Sleeve 25B-S1 should be secured to its cone using a fastener.

The proper location of Attachment Sleeve 25B-S1 relative to Locking Ring Pin 25C-S3 as well as the shape and size of all cuts on a cone can be determined through trial-and-error and experimentation (such as tracing for example).

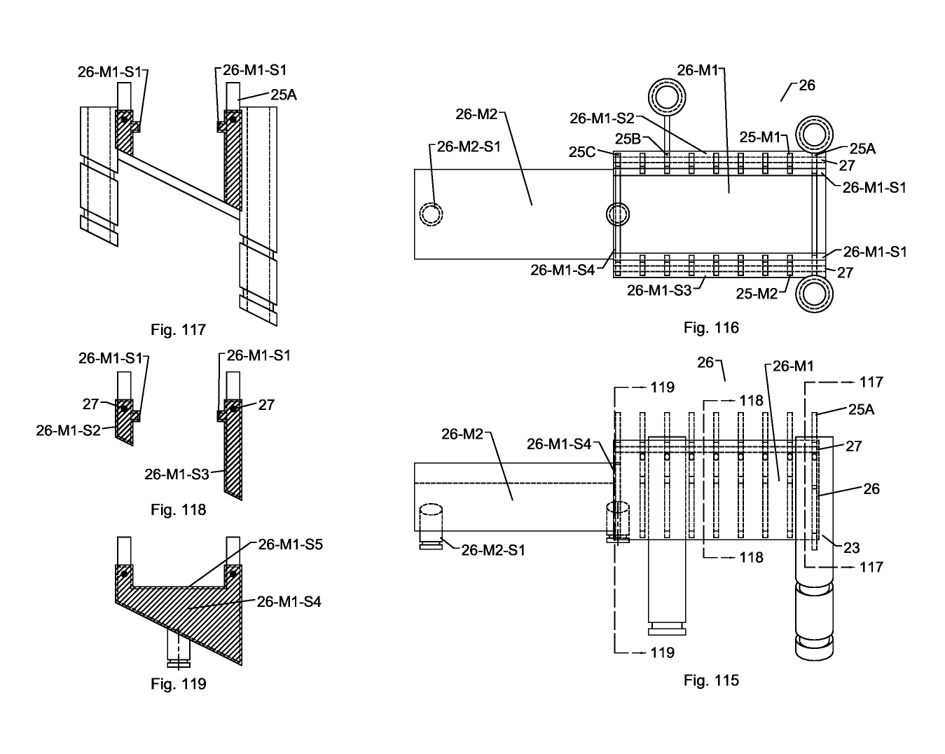

A Non-Torque Transmitting Member of this section, which is labeled as Non-Torque Transmitting Member 26, is shown in FIGS. 115 to 122. It comprises of a Non-Torque Transmitting Member Section 26-M1 and a Leveling Extension 26-M2. In its assembled state, Leveling Extension 26-M2 is inserted into its Torque Transmitting Member from which it will telescope in-and-out as the transmission diameter of its cone is changed. The purpose of Leveling Extension 26-M2 is to provide a base of for Teeth 21-S1 of Transmission Belt 21.

The Non-Torque Transmitting Member of this section has two separate elastomer side members that are joined at the leading end and trailing end (see FIG. 116 for a top-view and FIG. 118 for a sectional-view). One elastomer side member has Reinforcement Plates 25-M1 and a Trailing Sleeve Reinforcement Plate 25B (see FIG. 116); and the other elastomer side member has Reinforcement Plates 25-M2 (see FIG. 116). The two sides are then joined at the leading end and trailing end using Leading End Reinforcement Plate 25A and Trailing End Reinforcement Plate 25C (see FIG. 116). Each elastomer side member has a Reinforcement Wire 27.

A cross-section of Non-Torque Transmitting Member Section 26-M1 is shown in FIG. 118. In FIG. 118, the elastomer portions of said cross-section (which are sections of elastomer members) and the Reinforcement Wires 27 are shown in hatching. The left side elastomer member (labeled as Left Elastomer Member 26-M1-S2), “encases in elastomer”, and as such joins, the left side of Leading End Reinforcement Plate 25A, Reinforcement Plates 25-M1, Trailing Sleeve Reinforcement Plate 25B, and the left side of Trailing End Reinforcement Plate 25C (see FIG. 116). The right side elastomer member (labeled as Right Elastomer Member 26-M1-S3), “encases in elastomer”, and as such joins, the right side of Leading End Reinforcement Plate 25A, Reinforcement Plates 25-M2, and the right side of Trailing End Reinforcement Plate 25C (see FIG. 116).

The cross-section of Non-Torque Transmitting Member Section 26-M1 shown in FIG. 118 also has two Male Rails 26-M1-S1, which are shown in hatching, and as such are encased in elastomer. The bottom surfaces of Male Rails 26-M1-S1 are used to guide the Leveling Extension of its Torque Transmitting Member (which is inserted into Non-Torque Transmitting Member Section 26-M1). And the top surfaces of Male Rails 26-M1-S1 are used to provide a resting place for the Flanges 21-S2 of Transmission Belt 21. As according to the previous sentence, FIG. 121 shows the cross-section of FIG. 118, with the Leveling Extension of its Torque Transmitting Member (which is labeled as Leveling Extension 23-M2) and its Transmission Belt 21.

The cross-section shown in FIG. 118 (which is used to provide support for Flanges 21-S2 of Transmission Belt 21 and guide the Leveling Extension inserted into it) runs through the entire length of Non-Torque Transmitting Member Section 26-M1, except for the rear-end. Although the cross-section of Non-Torque Transmitting Member Section 26-M1 cut-through Leading End Reinforcement Plate 25A is also not identical, the elastomer in-cased portions of those two cross-sections (which are used to provide support for Flanges 21-S2 of Transmission Belt 21 and guide their Leveling Extension inserted into them) are identical. FIG. 117, shows a cross-section of Non-Torque Transmitting Member Section 26-M1 that is cut near Leading End Reinforcement Plate 25A.

The rear-end of Non-Torque Transmitting Member Section 26-M1, which is shown in FIG. 119, has a different cross-section than the rest of Non-Torque Transmitting Member Section 26-M1, this is because Leveling Extension 26-M2 needs to be attached to it. The elastomer portion of this cross-section (which is labeled as Rear Elastomer Member 23-M1-S4) and the Reinforcement Wires 24 are shown in hatching.

Rear Elastomer Member 23-M1-S4, shown in FIG. 119, has a Transmission Belt Base 26-M1-S5, which is used to provide a base for Teeth 21-S1 of Transmission Belt 21. As according to the previous sentence, FIG. 122 shows the cross-section of FIG. 119, with its Transmission Belt 21. For FIGS. 119 and 122, “the elastomer in-cased portions of the cross-sections shown” and “the Reinforcement Wires 27” are shown in hatching. If instead of Leveling Extensions, a Leveling Loop that can expand and contract is used, then this cross-section shown in FIG. 119 as well as Leveling Extension 26-M2 are not needed.

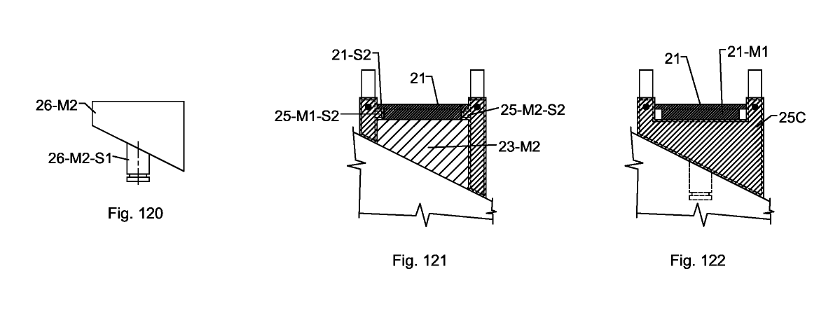

A rear-view of Leveling Extension 26-M2 is shown in FIG. 120. In its assembled state, Leveling Extension 26-M2 will be inserted into Transmitting Member Section 23-M1. Leveling Extension 26-M2 also has a Locking Ring Pin 26-M2-S1. Locking Ring Pin 26-M2-S1 is used to secure the rear-end of Leveling Extension 26-M2 to its cone using fasteners such as a Dome Shaped Nut or Ball Clamp (which is preferred) for example. The shape and size of the cut for Locking Ring Pin 26-M2-S1 on its cone can be determined through trial-and-error and experimentation (such as tracing for example).

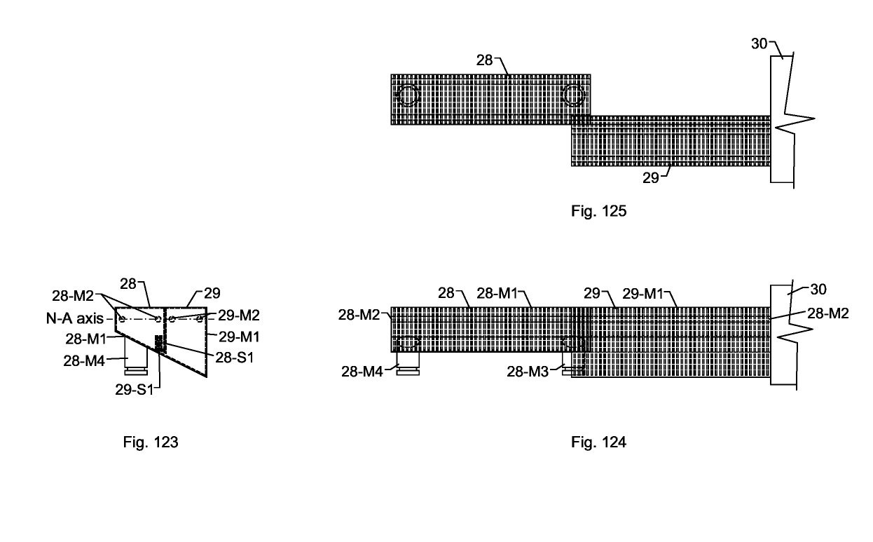

In order to allow for greater transmission ratio range, Leveling Extension 23-M2 of Torque Transmitting Member 23 and Leveling Extension 26-M2 of Non-Torque Transmitting Member 26 can be replaced with a Leveling Extension that consist two separate Leveling Extensions for which one Leveling Extension can telescope in-and-out of the other Leveling Extension. This kind of Leveling Extension (Telescoping Leveling Extension) is shown in FIGS. 123 to 125, where the separate Leveling Extensions are labeled as Leveling Extension 28 and Leveling Extension 29; Leveling Extension 29 is attached to a Member 30, which can be a Torque Transmitting Member 23 or Non-Torque Transmitting Member 26.

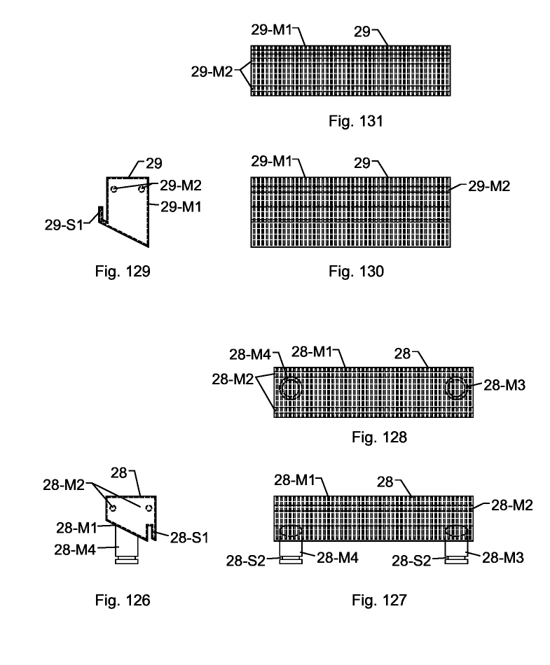

FIGS. 123 to 125 show Leveling Extension 28 and Leveling Extension 29 in their assembled state. Leveling Extension 28 is shown by itself in FIGS. 126 to 128. And Leveling Extension 29 is shown by itself in FIGS. 129 to 131.

Leveling Extension 28 has a Hook Rail 28-S1 and Leveling Extension 29 has a Hook Rail 29-S1 (see FIGS. 123, 126, and 129). Hook Rails 28-S1 and 29-S1 are used to keep the separate Leveling Extensions together. And the Hook Rails also allow that only Leveling Extension 28 is attached to its cone in a manner as to prevent it from separating from its cone due to centrifugal forces; since if Leveling Extension 28 is prevented from separating from its cone due to centrifugal forces, then Hook Rails 28-S1 and 29-S1 will also prevent Leveling Extension 29 from separating from its cone due to centrifugal forces.

In order to prevent Leveling Extension 28 from separating from its cone due to centrifugal forces, Leveling Extension 28 has a Leading End Locking Ring Pin 28-M3 and a Trailing End Locking Ring Pin 28-M4 (see FIGS. 124 and 127). Leading End Locking Ring Pin 28-M3 and Trailing End Locking Ring Pin 28-M4 will each be inserted into a designated cut on their cone and then secured to their cone by sliding a fastener such as a Dome Shaped Nut or a Ball Clamp (which is preferred) into them, and then securing the fastener by inserting a Locking Ring into each of their Locking Ring Grooves 28-S2 (see FIG. 127). The shape and size of the cuts for Leading End Locking Ring Pin 28-M3 and Trailing End Locking Ring Pin 28-M4 on their cone can be determined through trial-and-error and experimentation (such as tracing for example).

Leveling Extension 28 also has Reinforcement Plates 28-M1, and Leveling Extension 29 also has Reinforcement Plates 29-M1. Reinforcement Plates 28-M1 and 29-M1 are primarily used to strengthen the Hook Rails 28-S1 and 29-S1, and help maintain the dimensional integrity of Leveling Extension 28 and Leveling Extension 29. Although preferred, Reinforcement Plates 28-M1 and 29-M1 are not absolutely necessary and can be omitted if desired.

In addition, Leveling Extension 28 also has Reinforcements Wires 28-M2, and Leveling Extension 29 also has Reinforcement Wires 29-M2. Reinforcements Wires 28-M2 and 29-M2 are primarily used to help ensure that the neutral-axis (neutral-bending-axis) of Leveling Extension 28 and Leveling Extension 29 coincide or almost coincide so as to provide a smoother and better fit between Hook Rails 28-S1 and 29-S1; and to increase the lateral, bending, and axial stiffness of Leveling Extension 28 and Leveling Extension 29. Although preferred, Reinforcements Wires 28-M2 and 29-M2 are not absolutely necessary and can be omitted if desired. Also in the figures, the location of Reinforcements Wires 28-M2 and Reinforcement Wires 29-M2 might not be shown at the actual location as required to have the neutral-axis (neutral-bending-axis) of Leveling Extension 28 and Leveling Extension 29 coincide or almost coincide; however, somebody skilled in the art should be able to accurately place the location of the reinforcement wires as required.

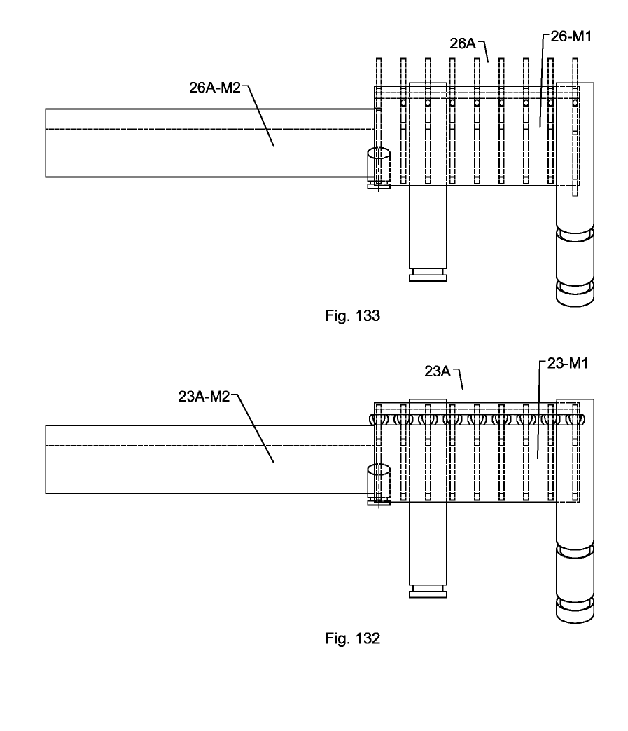

FIG. 132 shows a Torque Transmitting Member 23A. Torque Transmitting Member 23A is identical to Torque Transmitting Member 23, except that it has a longer Leveling Extension, and that its Leveling Extension does not have a Locking Ring Pin. The Leveling Extension of Torque Transmitting Member 23A is labeled as Leveling Extension 23A-M2

The Torque Transmitting Member Section of Torque Transmitting Member 23A, which is labeled as Torque Transmitting Member Section 23-M1, is identical to the Torque Transmitting Member Section 23-M1 shown in FIGS. 96 to 100 and described earlier.

FIG. 133 shows a Non-Torque Transmitting Member 26A. Non-Torque Transmitting Member 26A is identical to Non-Torque Transmitting Member 26, except that it has a longer Leveling Extension, and that its Leveling Extension does not have a Locking Ring Pin. The Leveling Extension of Non-Torque Transmitting Member 26A is labeled as Leveling Extension 26A-M2.

The Non-Torque Transmitting Member Section of Non-Torque Transmitting Member 26A, which is labeled as Non-Torque Transmitting Member Section 26-M1, is identical to the Non-Torque Transmitting Member Section 26-M1 shown in FIGS. 115 to 119 and described earlier.

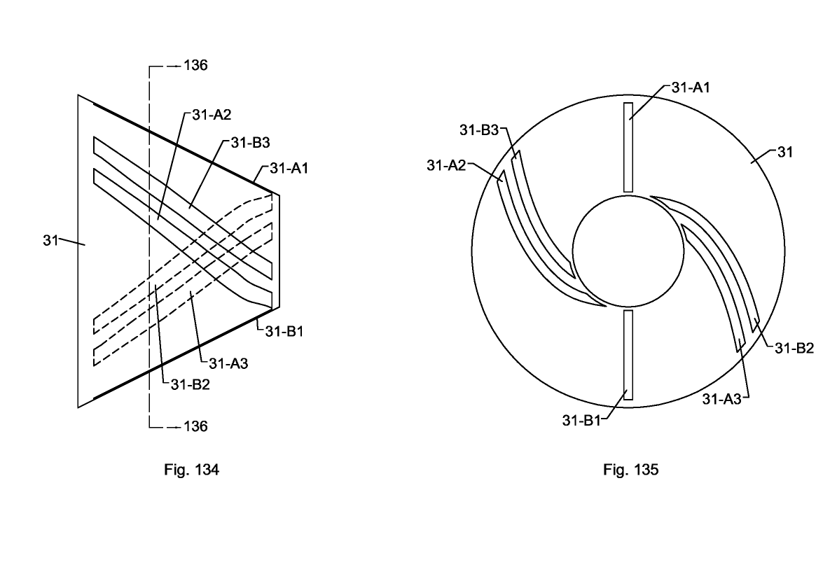

Torque Transmitting Member 23A and Non-Torque Transmitting Member 26A can be used with a cone that has one cut for inserting a portion of Leveling Extension 23A-M2; and another cut for inserting a portion of Leveling Extension 26A-M2; such as Cone 31, shown in FIGS. 134 and 135.

For Torque Transmitting Member 23A, Cone 31 (see FIGS. 134 and 135) has the following cuts: a) Torque Transmitting Member Leading End Cut 31-A1, into which the sleeves of Leading End Reinforcement Plate 22A are inserted; b) Torque Transmitting Member Trailing End Cut 31-A2 (into which Locking Ring Pin 22C-S3 and Attachment Sleeve 22B-S1, 22D-S1, or 22E-S1 are inserted; and c) Torque Transmitting Member Leveling Extension Insertion Cut 31-A3, through which Leveling Extension 23A-M2 is inserted into Cone 31.

For Non-Torque Transmitting Member 26A, Cone 31 (see FIGS. 134 and 135) has the following cuts: a) Non-Torque Transmitting Member Leading End Cut 31-B1, into which the sleeves of Leading End Reinforcement Plate 25A are inserted; b) Non-Torque Transmitting Member Trailing End Cut 31-B2 (into which Locking Ring Pin 25C-S3 and Attachment Sleeve 25B-S1 are inserted); and c) Non-Torque Transmitting Member Leveling Extension Insertion Cut 31-B3, through which Leveling Extension 26A-M2 is inserted into Cone 31.

The cuts shown in FIGS. 134 and 135 are not to scale and are not accurately drawn, but they represent the actual relative positions where they should be located. Somebody skilled in the art should be able to determine the accurate shape of the cuts through tracing, mathematics, etc.

Also Non-Torque Transmitting Member Leveling Extension Insertion Cut 31-B3 is preferably as close as practical to Torque Transmitting Member Trailing End Cut 31-A2; and Torque Transmitting Member Leveling Extension Insertion Cut 31-A3 is preferably as close as practical to Non-Torque Transmitting Member Trailing End Cut 31-B2. So that Leveling Extension 23A-M2 and Leveling Extension 26A-M2 can provide the most coverage for the base of their Transmission Belt.

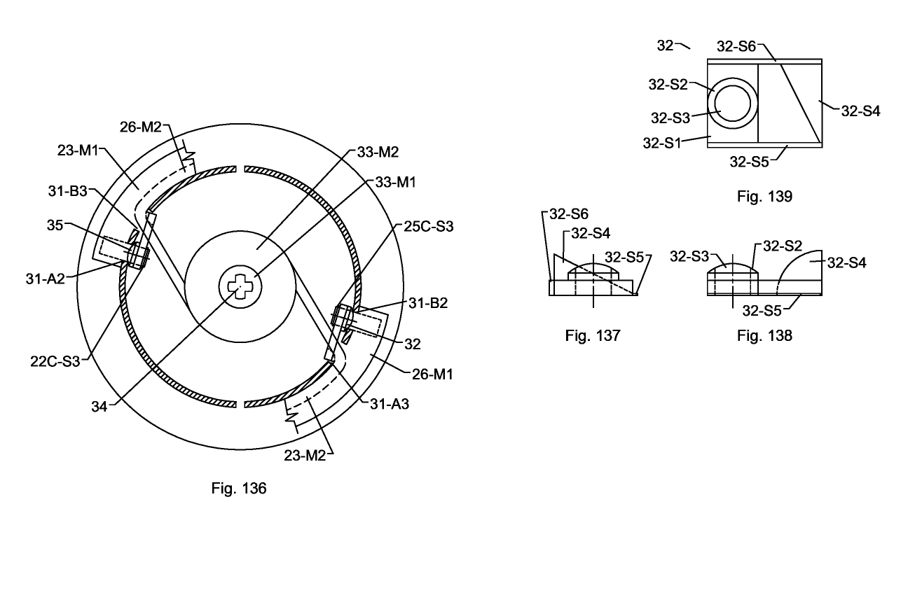

And also in FIG. 136 are a section of Torque Transmitting Member Section 23-M1 and a section of Non-Torque Transmitting Member Section 26-M1. The Trailing End of Torque Transmitting Member Section 23-M1 is attached to Cone 31 through the use of a Dome 32 that is slid onto Locking Ring Pin 22C-S3 and then secured using a Locking Ring; and the Trailing End of Non-Torque Transmitting Member Section 26-M1 is attached to Cone 31 through use of another Dome 32 that is slid onto Locking Ring Pin 25C-S3 and then secured using a Locking Ring. The Domes 32 also have a partial conical surface that is used to provide a resting place for their leveling extension as it enters Cone 31 (see FIGS. 137 to 139).

The trailing ends of Leveling Extension 26A-M2 and Leveling Extension 23A-M2 are fixed to a Loop Wheel 33-M2. Loop Wheel 33-M2 is mounted on a Loop Wheel Hub 33-M1, in a manner so that it can rotate relative to Loop Wheel Hub 33-M1, but not move axially relative to Loop Wheel Hub 33-M1.

Loop Wheel Hub 33-M1 is attached to the Spline 34 of Cone 31 in a manner so that it cannot move axially nor rotate relative to Spline 34. But since Spline 34 can move axially relative to Cone 31, Loop Wheel Hub 33-M1 can also move axially relative to Cone 31.

Loop Wheel 33-M2 is rotated relative to its Loop Wheel Hub 33-M1 by a spring or other means so that Leveling Loop 26A-M2 and Leveling Loop 23A-M2 are tightly wrapped around Loop Wheel 33-M2 (see arrow of FIG. 136); due to this, the length of Leveling Loop 26A-M2 and Leveling Loop 23A-M2 are adjusted according to the diameter of the axial section of Cone 31 where they are positioned.

A Dome 32, which was mentioned earlier, is shown in detail in FIGS. 137 to 139. Dome 32 has a Block 32-S1. On top of Block 32-S1 a Dome Shape 32-S2 is shaped; Dome Shape 32-S2 is shaped so that it is the only surface of Dome 32 that engages the inner surface of its cone. In order to be able to insert Dome 32 into a Locking Ring, Dome 32 has a Hole 32-S3, which extends all the way from the top surface of Dome 32 through the bottom surface of Dome 32.

And although not absolutely necessary, but preferred, in order reduce “leveling loop wear” Dome 32 also has a Partial Conical Surface 32-S4, which provides a resting place for its leveling extension as it enters its cone. Partial Conical Surface 32-S4 is connected to Block 32-S1 through Side Flange 35-S2 and Side Flange 35-S2. Partial Conical Surface 32-S4 is preferably placed inside its cut; if this is not practical then it can be placed below its cut.

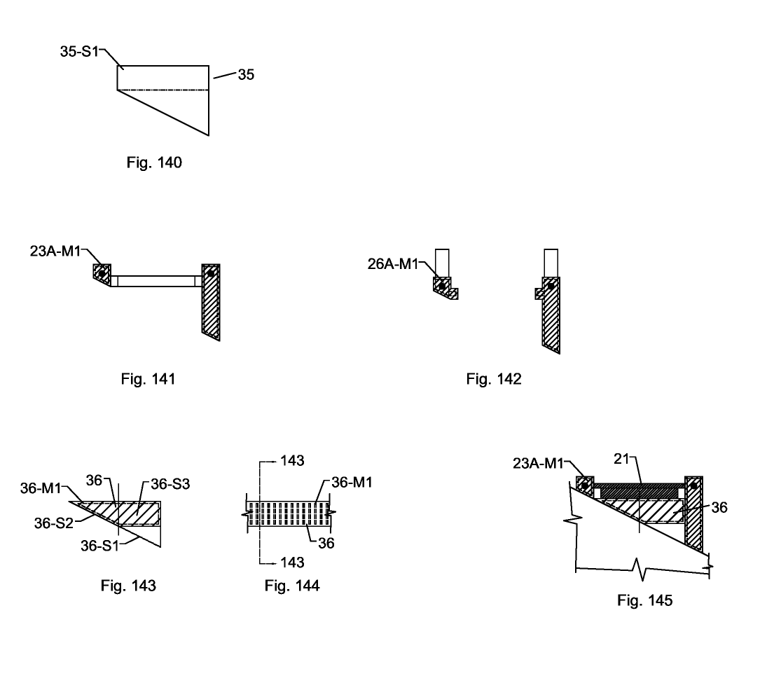

In order to reduce/minimize the thickness of a Leveling Extension, so as to reduce the cut required for it to enter its cone, the teeth of its Torque Transmitting Member Section can be placed closer to the surface of their cone; since this will reduce/eliminate the thickness of Shape 35-S1 of a Leveling Extension 35 (see FIG. 140).

In order to place the teeth of a Torque Transmitting Member Section closer to the surface of their cone, the cross-section of Torque Transmitting Member Section 23-M1, shown in FIG. 99 can be reshaped as shown in FIG. 141. The cross-section shown in FIG. 141 is for a Torque Transmitting Member Section 23A-M1. Torque Transmitting Member Section 23A-M1 is identical to Torque Transmitting Member Section 23-M1, except that its shaped so that its teeth are position closer to the surface of their cone compared to Torque Transmitting Member Section 23-M1. A cross section of a Non-Torque Transmitting Member 26A-M1 that can be used with Torque Transmitting Member Section 23A-M1 is shown in FIG. 142.

Placing the teeth (or specifically the bottom surface of the teeth) of a Torque Transmitting Member Section closer to the surface of their cone will reduce the allowable width of said Torque Transmitting Member Section; this is due the possible interference between the “larger diameter side surface” of said Torque Transmitting Member Section and the surface of its cone. In order to overcome this problem, larger teeth can be used; since larger teeth will place the neutral axis of its transmission belt further away from the surface of its cone (which will allow in an increase in width of its Torque Transmitting Member Section.

Another method for reducing the thickness of a Leveling Extension is by removing a portion of the bottom surface of the Leveling Extension that is resting on the surface of its cone, a Leveling Extension for which this method is used is shown in FIGS. 143 and 144. FIG. 143 shows an end-sectional view of a Leveling Extension 36, for which its Bottom Surface 36-S1 has been removed; while FIG. 143 show a side view of Leveling Extension 36.

Leveling Extension 36 can be used as the Leveling Extension for Torque Transmitting Member and a Non-Torque Transmitting Member; such as by replacing Leveling Extension 23A-M2 of Torque Transmitting Member 23A (see FIG. 132), and by replacing Leveling Extension 26A-M2 of Non-Torque Transmitting Member 26A (see FIG. 133) for example.

In order to prevent Leveling Extension 36 from tipping-over, the Bottom Surface of Leveling Extension 36 that is resting on the surface of its cone (which is labeled as Bottom Surface 36-S2) should be at least as wide (but preferably slightly wider) as the Bottom Surface that has been removed (which is labeled as Bottom Surface 36-S1).

An in order for Leveling Extension 36 to be able to support the portion of its Transmission Belt that is resting on a portion of Leveling Extension 36 for which its bottom surface is not resting on the surface of its cone, which is labeled as Portion 36-S3 in FIG. 143, Leveling Extension 36 has reinforcement plates 36-M1. Note, the dotted lines of FIG. 143 do not show real/physical features, but are only used for explanatory purposes.

FIG. 145 shows a cross-section of Torque Transmitting Member Section 23A-M1, its Transmission Belt 21, and the Leveling Extension 36 inserted into it. The dotted line in FIG. 145 is at the mid-width of Transmission Belt 21. And as per the previous paragraph, the in order to prevent Leveling Extension 36 from tipping-over, the Bottom Surface of Leveling Extension 36 that is resting on the surface of its cone is slightly wider then Bottom Surface that has been removed.

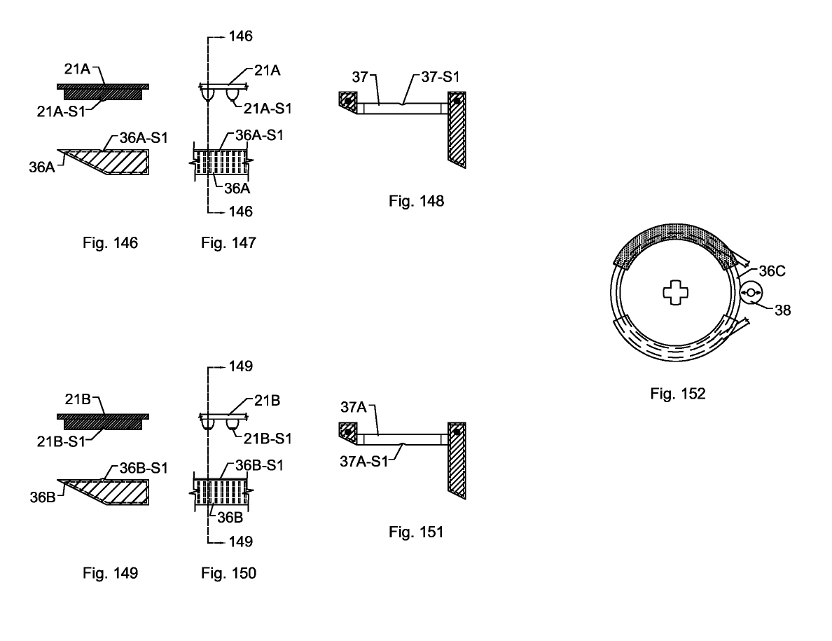

A slightly modified Transmission Belt 21 and its slightly modified Leveling Extension 36 are shown in FIGS. 146 and 147. Here, in order to have Transmission Belt 21A help maintain the alignment of its Leveling Extension 36A on the surface of its cone, the teeth of said Transmission Belt 21A have Protrusions 21A-S1 that enter a Channel 36A-S1 of its Leveling Extension 36A when said Transmission Belt 21A is resting on its Leveling Extension 36A.

If Protrusions 21A-S1 interfere with the teeth of its Torque Transmitting Member, then the teeth of its Torque Transmitting Member can be reshaped as necessary. As an example, FIG. 148 shows a Tooth 37 that has a Cut 37-S1 to provide clearance for Protrusions 21A-S1.

Another slightly modified Transmission Belt 21 and its slightly modified Leveling Extension 36 are shown in FIGS. 149 and 150. Here, in order to have Transmission Belt 21 B help maintain the alignment of its Leveling Extension 36B on the surface of its cone, the teeth of said Transmission Belt 21B have a Cut 21B-S1 into which a Protrusion 36B-S1 of its Leveling Extension 36A enter when said Transmission Belt 21B is resting on its Leveling Extension 36BS.

If Protrusions 21B-S1 interfere with the teeth of its Torque Transmitting Member, then the teeth of its Torque Transmitting Member can be reshaped as necessary. As an example, FIG. 151 shows a Tooth 37A that has a Cut 37A-S1 to provide clearance for Protrusions 36B-S1.

In order to help maintain the alignment of a Leveling Extension 36C, which can be a Leveling Extension 36B or 36C. A Support Wheel 38 can be used. Support Wheel 38 is shaped so that it can be used to help maintain the alignment of its Leveling Extension; and it is pushed towards the surface of its cone by a spring or other means in a manner so that it maintains contact with its Leveling Extension for all Transmission Diameters of its Cone while allowing the Transmission Diameter of its cone to increase or decrease as needed.

### “Torque Transmitting Member/Non-Torque Transmitting Member Section Rear End” With Leveling Extension Insertion Guides

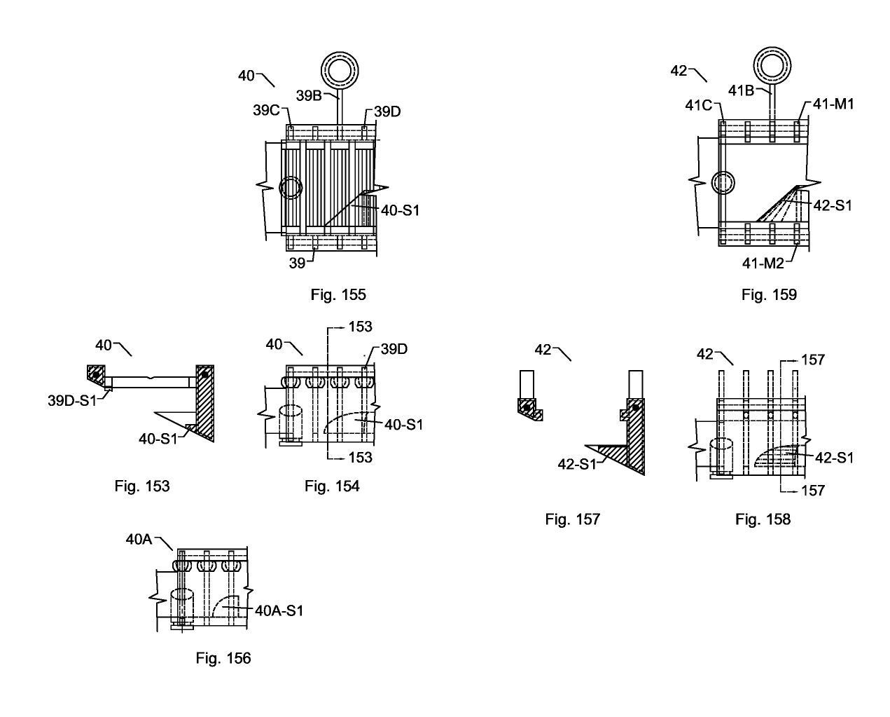

FIGS. 153 to 155 show a Torque Transmitting Member Section Rear End 40 that can be used as the rear end of a Torque Transmitting Member Section 23A-M1; and with slight dimensional modifications, as the rear end of a Torque Transmitting Member Section 23-M1.

Except for its cross-sectional shape (refer to the description for FIG. 141), Reinforcement Plate 39, Trailing Sleeve Reinforcement Plate 39B, and Trailing End Reinforcement Plate 39C of a “Torque Transmitting Member Section 23A-M1” are basically identical to Reinforcement Plate 22, Trailing Sleeve Reinforcement Plate 22B, and Trailing End Reinforcement Plate 22C of a Torque Transmitting Member Section 23-M1. As such, only modification to the cross-sectional shape of the reinforcement plates are required in order to apply the methods of this section to a Torque Transmitting Member Section 23-M1.

In order to guide the “Leveling Extension inserted into it” into its cone, Torque Transmitting Member Section Rear End 40 has a Leveling Extension Insertion Guide 40-S1 shaped/molded to it.

Since Trailing End Reinforcement Plate 39C does have an opening that allows for a Leveling Extension to pass through, as many reinforcement plates that allow a Leveling Extension to pass through (such as Reinforcement Plate 22 and Trailing Sleeve Reinforcement Plate 39B) should be placed between “the location where Leveling Extension Insertion Guide 40-S1 starts to bend said Leveling Extension into its cone” and Trailing End Reinforcement Plate 39C, in manner that allows said Leveling Extension to enter its cone smoothly.

Leveling Extension Insertion Guide 40-S1 is shaped so that it twists the Leveling Extension guided by it a manner as to reduce/minimize the cut required to insert said Leveling Extension into its cone. It is recommended that twisting of said the Leveling Extension occurs after said Leveling Extension has bent, so that the twisting mainly occurs by rotating the left side and right side of said Leveling Extension up-and-down relative each other, instead of bending the left side and right side of said Leveling Extension left-and-right relative each other; since this will allow said Leveling Extension to have some lateral stiffness.

Furthermore, Leveling Extension Insertion Guide 40-S1 also has a “Level Leveling Extension Support” that extends through the entire length of its Torque Transmitting Member Section, shaped in front its curved insertion guiding surface.

FIG. 156 shows an alternate Torque Transmitting Member Section Rear End 40A. Torque Transmitting Member Section Rear End 40A is identical to Torque Transmitting Member Section Rear End 40, except that its Leveling Extension Insertion Guide 40A-S1 does not twists the Leveling Extension guided by it. And, Leveling Extension Insertion Guide 40A-S1 does not have a “Level Leveling Extension Support” that extends through the entire length of its Torque Transmitting Member Section, shaped in front its curved insertion guiding surface.

The unique features of Torque Transmitting Member Section Rear End 40 can also be applied to a Non-Torque Transmitting Member. FIGS. 157 to 159 show a Non-Torque Transmitting Member Section Rear End 42 that can be used as the rear end of Non-Torque Transmitting Member Section 26A-M1; and with slight dimensional modifications, as the rear end of Non-Torque Transmitting Member Section 26-M1.

Except for its cross-sectional shape (refer to the description for FIG. 141), Reinforcement Plate 41-M1, Reinforcement Plate 41-M2, Trailing Sleeve Reinforcement Plate 41B, and Trailing End Reinforcement Plate 41C of a “Non-Torque Transmitting Member Section 26A-M1” are basically identical to a Reinforcement Plate 25-M1, Reinforcement Plate 25-M2, Trailing Sleeve Reinforcement Plate 25B, and Trailing End Reinforcement Plate 25C of a “Non-Torque Transmitting Member Section 26-M1”. As such, only modification to the cross-sectional shape of the reinforcement plates are required in order to apply the methods of this section to a Non-Torque Transmitting Member Section 26-M1.

Like Torque Transmitting Member Section Rear End 40, Non-Torque Transmitting Member Section Rear End 42 has a Leveling Extension Insertion Guide 42-S1 shaped/molded to it. Leveling Extension Insertion Guide 42-S1 is identical to Leveling Extension Insertion Guide 40-S1. The dash-dot lines of FIGS. 158 and 159 show the contour lines of the “Leveling Extension resting surface” of Leveling Extension Insertion Guide 42-S1. The shapes of Leveling Extension Insertion Guide 40-S1 and Leveling Extension Insertion Guide 42-S1 might not be accurately shown, but somebody skilled in the art should be able to come with an “at least somewhat useful shape” for a Leveling Extension Insertion Guide through simple experimentation.

Also if desired, the relevant reinforcement plates can be reshaped as to have a “Leveling Extension Insertion Guide Supporting Shape”.

### Torque Transmitting Chain Member, Non-Torque Transmitting Chain Member, and Leveling Loop For Multi-Stranded Chain

Examples for a Torque Transmitting Chain Member, Non-Torque Transmitting Chain Member, and Leveling Loop for a single-stranded chain were provided in the “Torque Transmitting Chain Member, Non-Torque Transmitting Chain Member, and Leveling Loop for a Uniformed Surfaced Cone” section; with some modifications, the same design can also be applied to multi-stranded chains. In this section, examples of how parts for a single-stranded chain can be modified for a two-stranded chain are provided. The same modification can also be applied to obtain 3-stranded chain, 4-stranded chain, 5-stranded chain, 6-stranded chain, etc.

A Torque Transmitting Chain Member for a single-stranded chain is shown in FIGS. 26 and 27. It mainly comprises of Links 6A and Links 6B that are joined together by Joiner Plates 5. And for mounting purposes said Torque Transmitting Chain Member also has: a) a Link 6A or Link 6B (Link 6B is used in FIGS. 26 and 27) that is modified to be shorter and modified to have Attachment Sleeves 7-S4; b) a Link 6A or Link 6B (Link 6B is used in FIGS. 26 and 27) that is modified to be shorter and modified to have a Slot Engagement Pin 8-S4; and c) a Joiner Plate 5 that is modified so that it has an Attachment Sleeve 5B-S1.

In order to form a Torque Transmitting Chain Member for a double-stranded chain, Links 6A and Links 6B and the modified Links 6A or Links 6B can be replaced by Links 43A and Links 43B and Links 43A or Links 43B that are modified in the same manner as the modified Links 6A or Links 6B. The Torque Transmitting Chain Member for a double-stranded chain can use the same Joiner Plates 5 and modified Joiner Plate 5 that were used for a Torque Transmitting Chain Member for a single-stranded chain. Links 43A and 43B are described below.

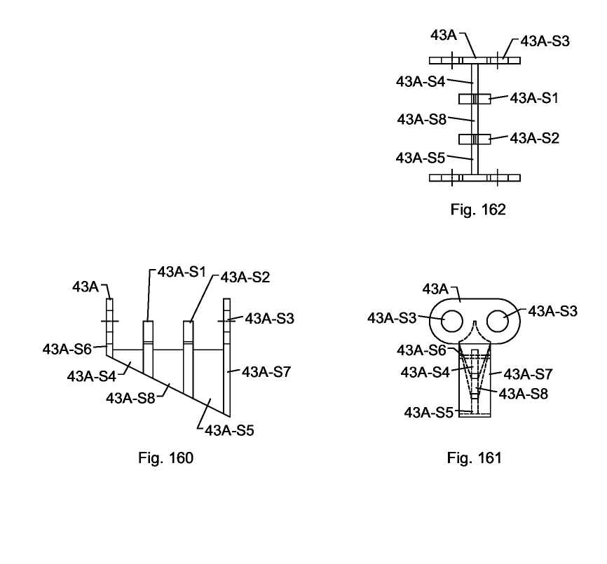

A Link 6A that is used in a Torque Transmitting Chain Member for single-stranded chain is shown in FIGS. 11 to 13. FIGS. 160 to 162 show a Link 43A, which is basically a Link 6A for use with a 2-stranded chain. Unlike Link 6A, Link 43A has two teeth, which are labeled as Tooth 43A-S1 and Tooth 43A-S2.

Like a Link 6A, Link 43A also has a four holes (two on each side), which here are labeled as Holes 43A-S3.

And like a Link 6A, Link 43A also has a two Tooth-to-Side Connectors, which here are labeled as Tooth-to-Side Connector 43A-S4 and Tooth-to-Side Connector 43A-S5. Tooth-to-Side Connector 43A-S4 is used to connect Tooth 43A-S1 to the left side of Link 43A through Side Connector-Extension 43A-S6. And Tooth-to-Side Connector 43A-S5 is used to connect Tooth 43A-S2 to the right side of Link 43A through Side Connector-Extension 43A-S7.

Since Link 43A has two teeth instead of one, unlike Link 6A, Link 43A also has a Tooth-to-Tooth Connector 43A-S8. A Tooth-to-Tooth Connector is used to connect two adjacent teeth. For a link, the left Tooth-to-Side Connector, the Tooth-to-Tooth Connectors, and the right Tooth-to-Side Connector form an unbroken connection from one side of the link to the other side of that link. This connection is used to transfer torque from the teeth to the sides of the link. If a Link has three teeth, then two Tooth-to-Tooth Connectors are required; if it has four teeth, then three Tooth-to-Tooth Connectors are required, if it has five teeth, then four Tooth-to-Tooth Connectors are required; if it has six teeth, then five Tooth-to-Tooth Connectors are required; and so forth.

Link 43A has three “narrow inner base portions”. One “narrow inner base portion” is formed by Tooth-to-Side Connector 43A-S4, one “narrow inner base portion” is formed by Tooth-to-Tooth Connector 43A-S8, and one “narrow inner base portion” is formed by Tooth-to-Side Connector 43A-S5. These “narrow inner base portions” allow for resting places on the surface of a cone for sections of a leveling loop. If desired instead of a Link 43A, a link with more or less “narrow inner base portions” can be used, as long as the link has at least one “narrow inner base portion” that allows for a resting place on the surface of a cone for a section of a leveling loop.

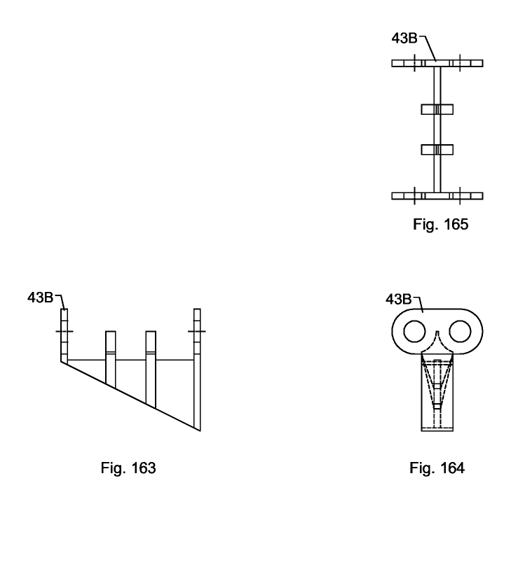

A Link 43B is shown in FIGS. 163 to 165. It has the same features has Link 43A, but it is wider and deeper. In the same manner as Link 6B is basically the wider and deeper version of Link 6A, Link 43B is basically the wider and deeper version of Link 43A.

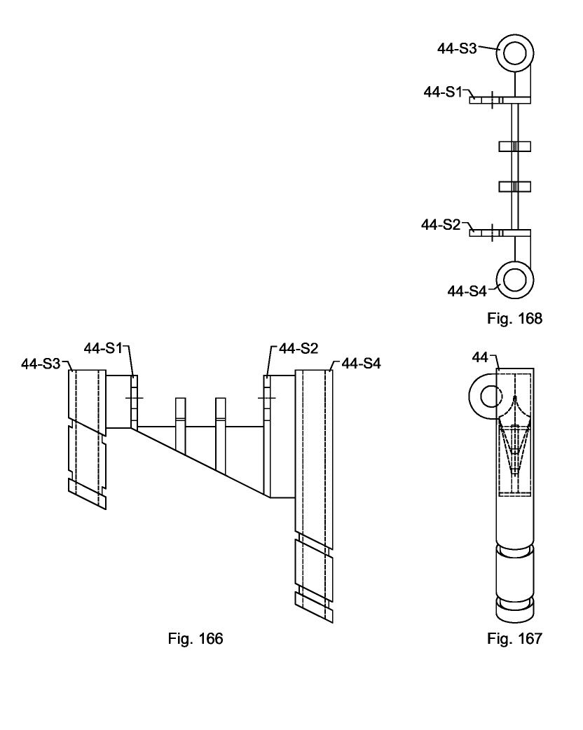

FIGS. 166 to 168 show Leading End Torque Transmitting Chain Member 44. Leading End Torque Transmitting Chain Member 44 is identical to Link 43B, except for its sides, which are labeled as Side 44-S1 and Side 44-S2. Unlike Link 43B, the sides of Leading End Torque Transmitting Chain Member 44 are shorter and as such have only 1 hole each instead of two; and unlike the sides of Link 43B, the sides of Leading End Torque Transmitting Chain Member 44 have Attachment Sleeves attached to them; these Attachment Sleeves are labeled as Attachment Sleeves 44-S3 and 44-S4.

Depending on the alternating-links arrangement of the Torque Transmitting Chain Member, in some configuration (such as Link 43B to Link 43A to Link 43B, instead of Link 43A to Link 43B to Link 43A for example), a Leading End Torque Transmitting Chain Member that is identical as described in the previous paragraph, except that its partial Link 43B portion is replaced with a partial Link 43A portion, has to be used.

Attachment Sleeves 44-S3 and 44-S4 are used to attach Leading End Torque Transmitting Chain Member 44 of a Torque Transmitting Chain Member to a torque transmitting member carriage 550A of a front pin belt cone assembly 520A of U.S. Pat. No. 8,628,439; using the same method that the sleeves of a leading end of a pin belt torque transmitting member 590 are attached to its torque transmitting member carriage 550A in U.S. Pat. No. 8,628,439 (refer to column 90 line 63 to column 91 line 48 of U.S. Pat. No. 8,628,439).

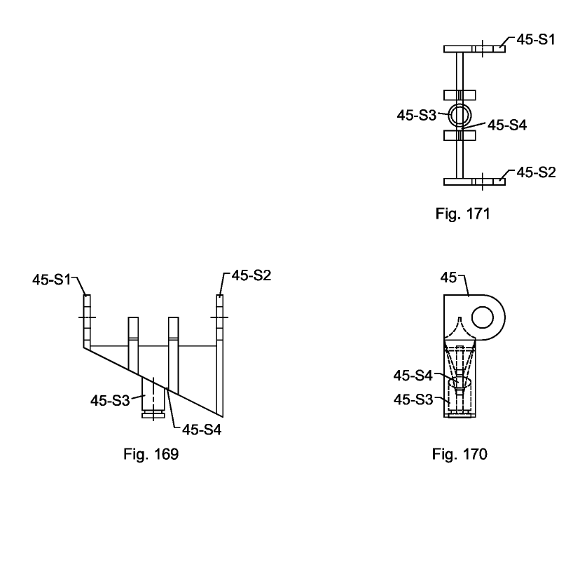

FIGS. 169 to 171 show Trailing End Link 45. Trailing End Link 45 is identical to Link 43B, except for: a) its sides, which are labeled as Side 45-S1 and Side 45-S2. Unlike Link 43B, the sides of Trailing End Link 45 are shorter and as such have only 1 hole each instead of two.

And b) unlike Link 43B, Trailing End Link 45 has a Slot Engagement Pin 45-S3 attached to the base of its Tooth-to-Tooth Connector, which here is labeled a Tooth-to-Tooth Connector 45-S4.

Trailing End Link 45 is used as the trailing end link of its Torque Transmitting Chain Member, and Slot Engagement Pin 45-S4 is used to secure the trailing end of its Torque Transmitting Chain Member to its cone.

Depending on the alternating-links arrangement of the Torque Transmitting Chain Member, in some configuration (such as Link 43B to Link 43A to Link 43B, instead of Link 43A to Link 43B to Link 43A for example), a Trailing End Link 45 that is identical as described in the previous paragraph, except that its partial Link 43B portion is replaced with a partial Link 43A portion, has to be used.

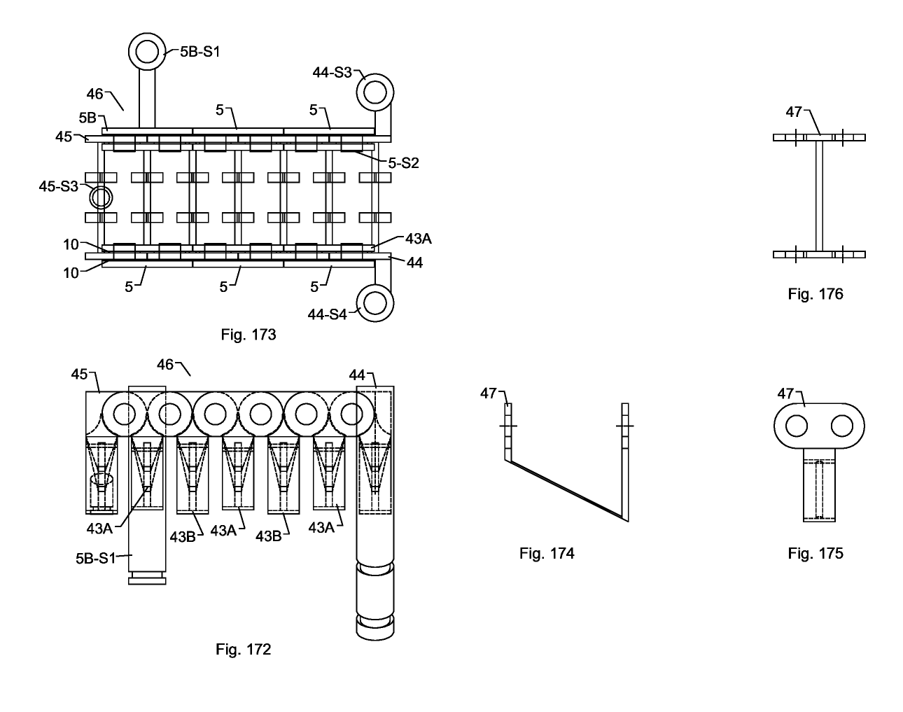

FIGS. 172 to 173, show a Torque Transmitting Chain Member for a double-stranded chain. This Torque Transmitting Chain Member, which is labeled as Torque Transmitting Chain Member 46, comprises of a Leading End Torque Transmitting Chain Member 44, alternating Links 43A and Links 43B, and a Trailing End Link 45 that are linked together by Joiner Plates 5 and a Trailing End Joiner Plate 5B, which were described previously.

The Joiner Plates 5 have Pins 5-S2, and each Pin 5-S2 is inserted through the holes of two adjacent links (here the links are: Leading End Torque Transmitting Chain Member 44, Links 43A, Links 43B, and Trailing End Link 45), so as to link them together. In FIGS. 172 to 173, each Pin 5-S2 is secured due to the friction between it and its hole of a Link 43A; because of this, it is recommended that the holes of Links 43A are smaller than the holes of the other links. Trailing End Joiner Plate 5B is identical to Joiner Plates 5, except that it also has an Attachment Sleeve 5B-S1.

In order to reduce friction, Washers 10, which should be made out of a low friction material, can be placed between all engaging side surfaces of two links, and between all engaging side surfaces of a link with a Joiner Plates 5 or Trailing End Joiner Plate 5B; however, this is not absolutely necessary, since the chain member can be used where it is submerged or coated in lubricants.

A Link 12A that is used in a Non-Torque Transmitting Chain Member for single-stranded chain is shown in FIGS. 30 to 32. FIGS. 174 to 176 show a Link 47, which is basically a Link 12A for use with a 2-stranded chain. In order to accommodate the additional strand, Link 47 is wider than Link 12A. All other non-toothed links of the Non-Torque Transmitting Chain Member for single-stranded chain can be modified in the same manner, if it is to be used for a 2-stranded chain.

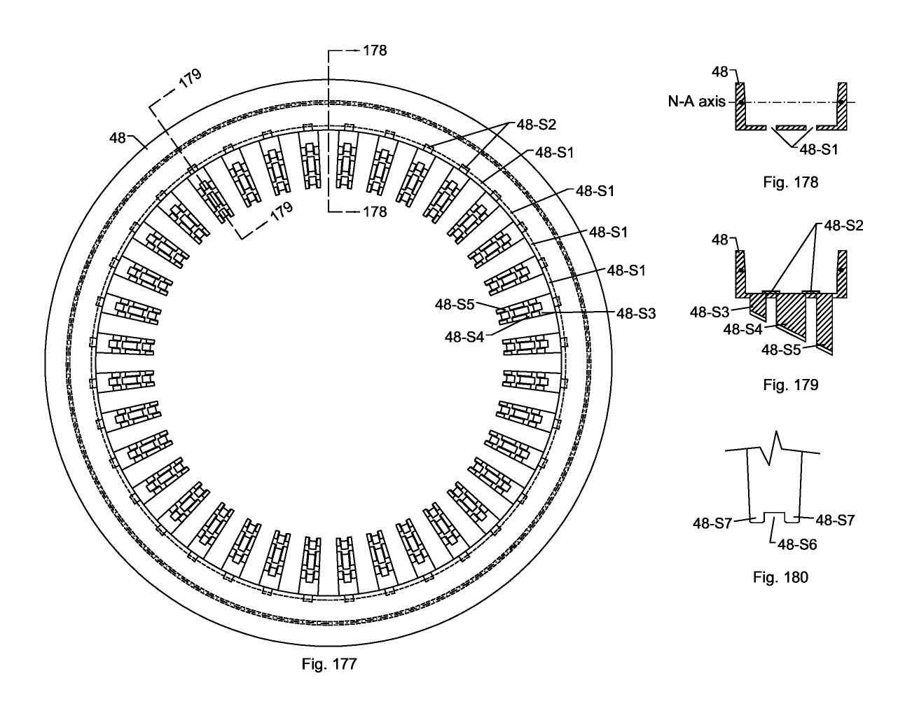

A Leveling Loop 16A that is used with a Torque Transmitting Chain Member and Non-Torque Transmitting Chain Member for single-stranded chain is shown in FIGS. 54 to 57. FIGS. 177 to 180 show a Leveling Loop 48, which is basically a Leveling Loop 16A for use with a 2-stranded chain. Unlike Leveling Loop 16A, Leveling Loop 48 has two Cut-outs for teeth (which are labeled as Cutouts 48-S1) instead of one along its width (see FIG. 178); and unlike Leveling Loop 16A, Leveling Loop 48 has two Resting Bases (which are labeled as Resting Bases 48-S2) instead of one along its width (see FIG. 179); and unlike Leveling Loop 16A, Leveling Loop 48 has three Legs (which are labeled as Legs 48-S3, 48-S4, 48-S5) instead of two along its width (see FIG. 179).

FIG. 180 shows a Leg of a Leveling Loop, its Groove 48-S6, and its Leg Bases 48-S7. Each Leg of a Leveling Loop (regardless if it is used for a single-stranded chain or multi-stranded chain) should have a bottom surface for which the corners are tapered, rounded, or not sharp; so that the Legs can slide-over the bases of their Non-Torque Transmitting Chain Member when the diameter of their cone is changed, and so that the bases of their Non-Torque Transmitting Chain Member can enter and exit its grooves. This might not be shown in all drawings, but should be so.

### Preferred Embodiment of the Invention (Best Mode)

The preferred embodiment of the invention is a Torque Transmitting Chain Member 11 that is used with a Non-Torque Transmitting Chain Member 16, and a Leveling Loop 16A.

### Conclusion, Ramifications, and Scope

While my above description contains many specificities, these should not be construed as limitations on the scope, but rather as an exemplification of one or several embodiment(s) thereof. Many other variations are possible.

Accordingly, the scope should be determined not by the embodiment(s) illustrated, but by the appended claims and their legal equivalents.

I claim:

1. A chain member for a “cone with one torque transmitting member”.
